(19) United States
(12) Patent Application Publication
(10) Pub. No.: US 2011/0206381 A1
(43) Pub. Date: Aug. 25, 2011

(54) OPTICAL SERIALIZING/DESERIALIZING APPARATUS AND METHOD AND METHOD OF MANUFACTURING SAME

(75) Inventors: Ho-Chul Ji, Yongin-si (KR); Kyoung Won Na, Seoul (KR); Sung Dong Suh, Seoul (KR); Kyoung Ho Ha, Seoul (KR); Seong Gu Kim, Pyeongtaek-si (KR); Dong Jae Shin, Seoul (KR); In Sung Joe, Seoul (KR)

(73) Assignee: SAMSUNG ELECTRONICS CO., LTD., Suwon-si (KR)

(21) Appl. No.: 12/911,417

(22) Filed: Oct. 25, 2010

(30) Foreign Application Priority Data
Feb. 25, 2010 (KR) 10-2010-0016981

(51) Int. Cl. H04B 10/00

(52) U.S. Cl. 398/140

(57) ABSTRACT

An optical serializer/deserializer (SERDES) includes serializing circuitry which includes a source of a plurality of unmodulated optical signals, a modulation unit for generating a plurality of modulated optical signals using a plurality of electrical signals to modulate the plurality of unmodulated optical signals, and a coupling unit for delaying the plurality of modulated optical signs to generate a plurality of delayed modulated optical signals and combines the delayed modulated optical signals to generate a serialized modulated optical signal. Deserializing circuitry of the SERDES includes an optical splitter for splitting a serialized modulated optical signal into a plurality of modulated split optical signals, a demodulation unit for demodulating the modulated split optical signals and generating a respective plurality of demodulated split optical signals, and a delay unit for delaying each of the plurality of demodulated split optical signals by a respective delay amount such that the serialized modulated optical signal is converted into a respective plurality of parallel demodulated split optical signals.

### RELATED APPLICATIONS

This application relies for priority under 35 U.S.C. 119 on Korean Patent Application number 10-2010-0016981, filed in the Korean Intellectual Property Office on Feb. 25, 2010, the entire contents of which application are incorporated herein by reference.

### BACKGROUND

1. Field of the Invention

The inventive concept relates to optical devices and methods, and, more specifically, to an optical serializer and deserializer used to convert parallel electrical signals to serialized optical signals, and, vice versa, and methods of manufacturing the optical serializer and deserializer.

2. Description of the Related Art

Optical devices such as optical fibers, optical waveguides and optical couplers are used for high-speed, low-power communication in various devices and systems. Optical interconnects have been used to achieve large-capacity, high-speed and low-power communication in semiconductor processors and memory devices, modules and systems. In such systems, optical fibers can be used to communicate between modules. The optical fibers can be coupled to the memory modules and devices by optical couplers, and the optical signals can be transmitted within modules and memory devices by optical waveguides.

In conventional electronic circuits, such as semiconductor memory devices and processors, electrical signals are typically processed and communicated by the circuitry in parallel. However, with the increasing demand for large capacity, low power and high speed, it is often desirable to transmit signals serially. To that end, the circuit can include a serializer which converts the parallel signals to a single serial signal. A deserializer circuit is used to convert the serialized signal back to multiple parallel signals.

### SUMMARY

One feature of the inventive concept is that it provides an optical serializer which converts a plurality of parallel electrical signals to a serialized optical signal.

Another feature of the inventive concept is that it provides an optical deserializer which converts a serial optical signal to a plurality of parallel electrical signals.

Another feature of the inventive concept is that it provides an optical serializer/deserializer (SERDES) which converts a plurality of parallel electrical signals to a serialized optical signal and converts a serial optical signal to a plurality of parallel electrical signals.

Another feature of the inventive concept is that it provides an integrated semiconductor device, such as a memory device, with an integrated optical serializer, deserializer or and/or SERDES.

Another feature of the inventive concept is that it provides a module, such as a memory module, having an optical interconnect system with an integrated optical serializer, deserializer and/or SERDES.

Another feature of the inventive concept is that it provides an optical interconnect system, such as an optical interconnect system for a memory system, in which memory devices on memory modules include integrated optical serializers, deserializers and/or SERDES circuits.

Another feature of the inventive concept is that it provides methods of manufacturing optical serializers, deserializers and SERDES devices, as well as memory devices, memory modules, memory systems and interconnection systems which include optical serializers, deserializers and/or SERDES circuits.

According to one aspect, the inventive concept is directed to an optical serializer. The optical serializer includes a source of a plurality of unmodulated optical signals. A modulation unit receives the plurality of unmodulated optical signals and a respective plurality of electrical signals and generates a respective plurality of modulated optical signals using the plurality of electrical signals to modulate the plurality of unmodulated optical signals. A coupling unit delays each of the plurality of modulated optical signals by a respective delay amount to generate a respective plurality of delayed modulated optical signals and combines the plurality of delayed modulated optical signals to generate a serialized modulated optical signal.

In one embodiment, the coupling unit comprises a delay unit and an optical coupler. The delay unit delays each of the plurality of modulated optical signals by the respective delay amount to generate the respective plurality of delayed modulated optical signals. The optical coupler combines the plurality of delayed modulated optical signals to generate the serialized modulated optical signal.

According to another aspect, the inventive concept is directed to an optical deserializer. The optical deserializer includes an optical splitter for splitting a serialized modulated optical signal into a respective plurality of modulated split optical signals. A demodulation unit demodulates the plurality of modulated split optical signals and generates a respective plurality of demodulated split optical signals. A delay unit delays each of the plurality of demodulated split optical signals by a respective delay amount such that the serialized modulated optical signal is converted into a respective plurality of parallel demodulated split optical signals.

In one embodiment, the deserializer further includes an optical-to-electrical conversion unit for converting the plurality of parallel demodulated split optical signals into a respective plurality of parallel electrical signals.

According to another aspect, the inventive concept is directed to an optical deserializer. The optical deserializer includes an optical splitter for splitting a serialized modulated optical signal into a respective plurality of modulated split optical signals. A demodulation unit demodulates the plurality of modulated split optical signals and generates a respective plurality of demodulated split optical signals. Each of a plurality of control signals is delayed by a respective delay amount to generate a respective plurality of delayed control signals, the plurality of delayed control signals being respectively applied to the plurality of demodulators such that the plurality of demodulated split optical signals are aligned in time.

In one embodiment, the deserializer further includes a delay unit for generating the plurality of delayed control signals.

In one embodiment, the plurality of delayed control signals are clock signals.

In one embodiment, the delay unit aligns the plurality of demodulated split optical signals in time.

In one embodiment, the deserializer further includes an optical-to-electrical conversion unit for converting the plurality of demodulated split optical signals aligned in time into a respective plurality of parallel electrical signals.

According to another aspect, the inventive concept is directed to a data processing system comprising a first transceiver circuit, a second transceiver circuit, and an optical communication channel between the first and second transceiver circuits. Each of the first and second transceiver circuits comprises a serializer/deserializer unit for converting between parallel electrical signals and a serialized optical signal, the serializer/deserializer unit introducing a plurality of delays into a respective plurality of split optical signals obtained by splitting an input optical signal.

In one embodiment, the input optical signal is the serialized optical signal being deserialized into the parallel electrical signals.

In one embodiment, the input optical signal is an unmodulated optical signal, the unmodulated optical signal being split and modulated by the plurality of parallel electrical signals to serialize the plurality of parallel electrical signals into the serialized optical signal.

In one embodiment, each serializer/deserializer comprises a plurality of delay circuits for introducing the plurality of delays.

In one embodiment, at least one of the first and second transceiver circuits is coupled to a semiconductor memory circuit.

In one embodiment, at least one of the first and second transceiver circuits is coupled to a processor circuit.

According to another aspect, the inventive concept is directed to a method of serializing a plurality of parallel electrical signals. According to the method, a plurality of unmodulated optical signals is received. The plurality of unmodulated optical signals is modulated to a plurality of parallel modulated optical signals using a respective plurality of parallel electrical signals. A respective plurality of delays are introduced into the plurality of parallel modulated optical signals to generate a respective plurality of delayed modulated optical signals. The plurality of delayed modulated optical signals are combined into a serialized modulated optical signal.

According to another aspect, the inventive concept is directed to a method of converting a serialized modulated optical signal to a plurality of parallel signals. According to the method, the serialized modulated optical signal is split into a plurality of modulated split optical signals. The modulated split optical signals are demodulated into a plurality of demodulated split optical signals. A respective plurality of delays are introduced into the plurality of demodulated split optical signals such that the plurality of demodulated split optical signals are aligned in time.

In one embodiment, the method further comprises converting the plurality of demodulated split optical signals into a plurality of parallel electrical signals.

According to another aspect, the inventive concept is directed to a method of converting a serialized modulated optical signal to a plurality of parallel signals. According to the method, the serialized modulated optical signal is split into a plurality of modulated split optical signals. The modulated split optical signals are demodulated into a plurality of demodulated split optical signals. A respective plurality of delays are introduced into a respective plurality of control signals used in demodulating the modulated split optical signals such that the plurality of demodulated split optical signals are aligned in time.

In one embodiment, the method further comprises converting the plurality of demodulated split optical signals into a plurality of parallel electrical signals.

### BRIEF DESCRIPTION OF THE DRAWINGS

The foregoing and other features and advantages of the inventive concept will be apparent from the more particular description of preferred embodiments of the inventive concept, as illustrated in the accompanying drawings in which like reference characters refer to the same parts throughout the different views. The drawings are not necessarily to scale, emphasis instead being placed upon illustrating the principles of the inventive concept. In the drawings, the thickness of layers and regions are exaggerated for clarity.

FIG. 1 contains a schematic functional block diagram of a processing system which uses electrical SERDES to convert between parallel and serial signal communication formats.

FIG. 2 contains a schematic functional block diagram of a processing system according to an exemplary embodiment of the inventive concept, which uses optical SERDES according to the inventive concept to convert between parallel and serial signal communication formats.

FIG. 3 contains a schematic block diagram of serializer circuitry, according to the SERDES circuitry of the inventive concept, according to an embodiment of the inventive concept.

FIGS. 4A through 4C contain schematic diagrams illustrating the serialization process of the serializer circuitry of FIG. 3.

FIG. 5 contains a schematic block diagram of deserializer circuitry, according to the SERDES circuitry of the inventive concept, according to an embodiment of the inventive concept.

FIGS. 6A through 6C contain schematic diagrams illustrating the deserialization process of the deserializer circuitry of FIG. 5.

FIG. 7 contains a schematic block diagram of deserializer circuitry, according to the SERDES circuitry of the inventive concept, in accordance with another embodiment of the inventive concept.

FIGS. 8A and 8B contain schematic diagrams illustrating the deserialization process of the deserializer circuitry of FIG. 7.

FIG. 9 is a schematic block diagram of an embodiment of deserializer circuitry, according to another embodiment of the inventive concept.

FIG. 10 is a schematic block diagram of an embodiment of deserializer circuitry, according to another embodiment of the inventive concept.

FIG. 11 is a schematic block diagram of a portion of a data processing system to which the optical SERDES according to the inventive concept can be applied.

FIG. 12 contains a schematic functional block diagram of a processing system according to an exemplary embodiment of the inventive concept, which uses optical SERDES according to the inventive concept to convert between parallel and serial signal communication formats.

FIG. 13 contains a schematic block diagram of a processing system to which the optical SERDES according to the inventive concept can be applied, according to an embodiment of the inventive concept.

FIG. 14 contains a schematic block diagram of a processing system to which the optical SERDES according to the inventive concept can be applied, according to an embodiment of the inventive concept.

FIG. 15 is a schematic flow diagram illustrating a method of converting a plurality of parallel electrical signals into a serialized optical signal, according to an embodiment of the inventive concept.

FIG. 16 is a schematic flow diagram illustrating a method of converting a serialized optical signal to a plurality of parallel electrical signals, according to an embodiment of the inventive concept.

FIG. 17 is a schematic flow diagram illustrating a method of converting a serialized optical signal to a plurality of parallel electrical signals, according to an embodiment of the inventive concept.

FIG. 18 is a schematic block diagram of a data processing system in which SPI serial communication, using the SERDES circuitry of the inventive concept, is used.

FIG. 19 is a schematic block diagram of a data processing system in which SATA serial communication, using the SERDES circuitry of the inventive concept, is used.

FIG. 20 is a schematic block diagram of a data processing system in which I²C serial communication, using the SERDES circuitry of the inventive concept, is used.

FIG. 21 is a schematic block diagram of a data processing system in which USB serial communication, using the SERDES circuitry of the inventive concept, is used.

FIG. 22 is a schematic block diagram of a data processing system in which CAN serial communication, using the SERDES circuitry of the inventive concept, is used.

FIG. 23 is a schematic block diagram of a system, which uses a plurality of serial communication interfaces which are maintained by the MIPI Alliance, and which include the SERDES circuitry according to the inventive concept.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

A serializer/deserializer (SERDES) is an integrated circuit (IC) or chip transceiver which converts parallel data to serial data and vice versa. The transmitter section is a serial-to-parallel converter, and the receiver section is a parallel-to-serial converter. Multiple SERDES interface circuits are commonly housed in a single package.

SERDES circuits facilitate the transmission of parallel data between two points over serial streams, reducing the number of data paths and, therefore, the number of connecting pins or wires required. Most SERDES devices are capable of full-duplex operation, i.e., data conversion and transmission can take place in both directions simultaneously. SERDES circuits are used in Gigabit Ethernet systems, wireless network routers, fiber optic communication systems, and storage applications. Specifications and speeds vary depending on the needs of the user and on the application. Some SERDES devices are capable of operating at speeds in excess of 10 Gbps.

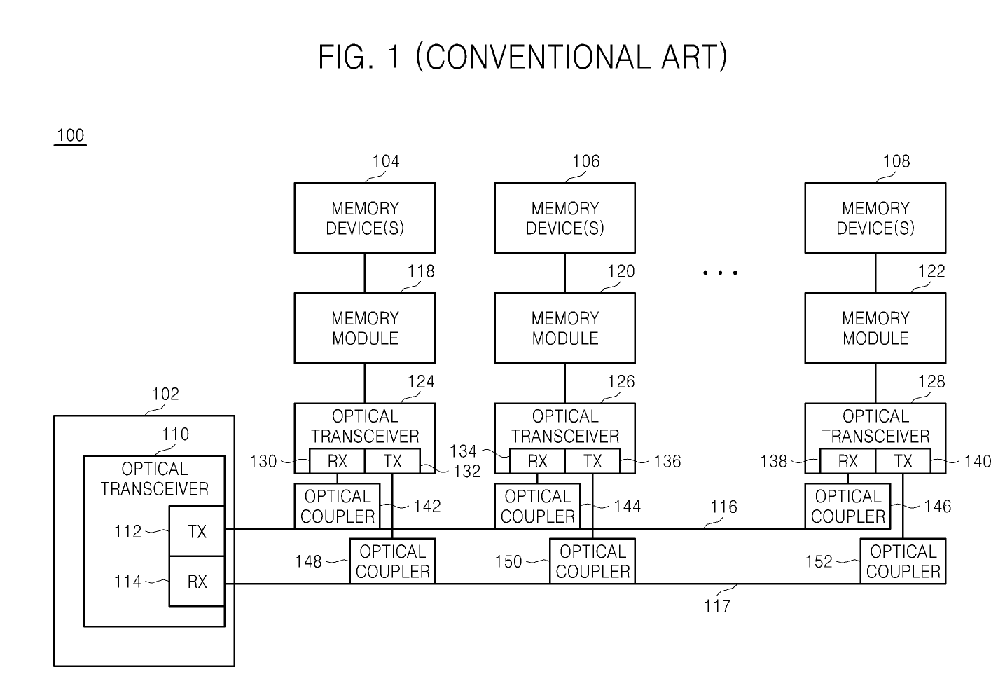

FIG. 1 contains a schematic functional block diagram of a processing system 100 which uses electrical SERDES to convert between parallel and serial signal communication formats. Referring to FIG. 1, the system 100 includes a processing circuit 102 communicating with a plurality of memory modules 104, 106, 108 via an optical communication bus 116, 117. The processing circuit 102 can be any type of circuit which communicates with memory circuits, such as a memory controller, a central processing unit (CPU), or other controlling or processing circuit. The memory devices 104, 106, 108 are mounted on memory modules 118, 120, 122, respectively. Each memory module 118, 120, 122 can be a dual inline memory module (DIMM) and may include a plurality of memory devices 104, 106, 108. One or more of the memory devices may be DRAM memory devices, in which case the memory modules 118, 120, 122 can be DRAM DIMMs.

The processing circuit 102 includes an optical transceiver 110 for transmitting and receiving optical signals to and from the optical bus 116, 117. The optical transceiver 110 includes an optical transmitter (TX) 112 which transmits optical signals on the optical bus 116 and an optical receiver (RX) 114 for receiving optical signals from the optical bus 117.

Each of the memory modules 118, 120, 122 is coupled to the optical bus 116, 117 via a respective associated optical transceiver 124, 126, 128. Each optical transceiver 124, 126, 128 includes a transmitter section 132, 136, 140 and a receiver section 130, 134, 138. Each transmitter section 132, 136, 140 transmits optical signals on the optical bus 117 via an optical coupler 148, 150, 152, respectively, and each receiver section 130, 134, 138 receives optical signals from the optical bus 116 via an optical coupler 142, 144, 146.

In the system 100, electrical SERDES is performed. That is, parallel electrical signals are converted to serial electrical signals, and vice versa. Conversion between electrical and optical domains is performed as an operation separate from the optical/electrical (O/E) and electrical/optical (E/O) conversion operations.

In operation of the system 100, the memory devices 104, 106, 108 and memory modules 118, 120, 122 process electrical signals. Likewise, generally, the internal circuitry of the processing system 102 processes electrical signals. Electrical signals from the memory devices 104, 106, 108 and memory modules 118, 120, 122 are received by the transmitters 132, 136, 140, which convert the electrical signals to optical signals and transmit the converted signals onto the optical bus 117 via optical couplers 148, 150, 152. The receiver section 114 of the transceiver 110 in the processing system 102 receives the optical signal from the optical bus 117, converts it to one or more electrical signals, and forwards the converted electrical signals to the other internal circuitry of the processing system 102 for processing. The transmitter section 112 of the transceiver 110 in the processing system 102 receives electrical signals from the other internal circuitry of the processing system 102, converts the electrical signals to an optical signal, and transmits the converted optical signal on the optical bus 116. The system 100 of FIG. 1 may include a quantity N memory modules 118, 120, 122 and N respective associated optical transceivers 124, 126, 128. Each memory module 118, 120, 122 may include a quantity M memory devices 104, 106, 108. Each receiver section 130, 134, 138 of the transceivers 124, 126, 128 receives from the optical bus 116 1/N of the total optical signal via an optical coupler 142, 144, 146, converts that 1/N portion of the optical signal to one or more electrical signals, and forwards the converted electrical signals to its respective memory module 118, 120, 122 for processing.

Thus, the conventional optical interconnection system illustrated in FIG. 1 relies on electrical SERDES. That is, in the system 100 of FIG. 1, it is electrical signals that are serialized and deserialized. In contrast, according to the inventive concept, optical SERDES is used. That is, according to the inventive concept, optical signals are serialized and deserialized.

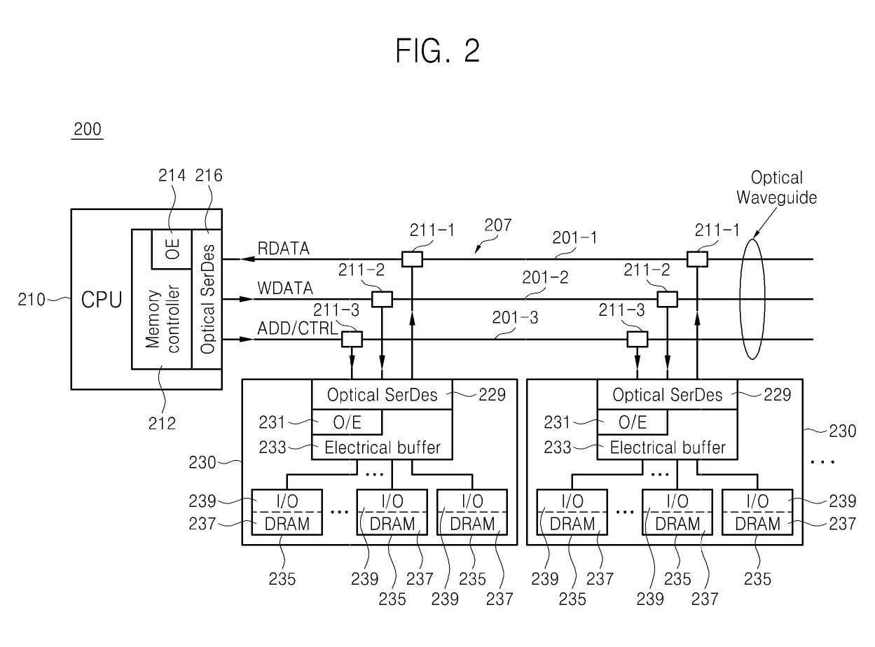

FIG. 2 contains a schematic functional block diagram of a processing system 200 according to an exemplary embodiment of the inventive concept, which uses optical SERDES according to the inventive concept to convert between parallel and serial signal communication formats. Referring to FIG. 2, the illustrative exemplary embodiment of the processing system 200 is a DRAM interface (I/F) system, which processes data to and from DRAM memory circuits. It should be noted that this exemplary embodiment of the inventive concept is for illustration purposes. As described herein in detail, the inventive concept is applicable to other types of systems.

Referring to FIG. 2, the system 200 includes a processing system 210, e.g., a CPU, which is coupled to a plurality of memory modules 230 via an optical bus 207. The optical bus 207 is shown to include three optical lines 201-1, 201-2, and 201-3, which can be implemented as one or more optical waveguides. The lines 201-1, 201-2, and 201-3 are coupled between the memory modules 230 and the processing system 210 by optical couplers 211-1, 211-2, and 211-3. In one particular embodiment, such as the DRAM I/F embodiment illustrated in FIG. 2, one of the lines 201-1 is a read data RDATA line, one of the lines 201-2 is a write data WDATA line, and one of the lines 201-3 is an address/control ADD/CTRL line. In each line, the information to be transmitted over the bus 207 is in serialized format and is transmitted optically.

Each of the memory modules 230 includes interface circuitry, which includes the optical SERDES circuitry 229, optical-to-electrical and electrical-to-optical conversion (O/E) circuitry 231, and an electrical buffer 233. Each DRAM circuit 235 includes DRAM memory 237 and DRAM I/O circuitry 239. The processing system 210 also includes interface circuitry, which includes a memory controller 212, the optical SERDES circuitry 216, and optical-to-electrical and electrical-to-optical conversion (O/E) circuitry 214.

In the system 200, data and control signals are transferred back and forth between the processing system 210 and the memory modules 235 under the control of the memory controller 212. The memory controller 212 generates all of the timing and control signals required to implement data read operations for reading data from the memory devices 235, data write operations for writing data to the memory devices 235, and any other operations to be performed by the memory devices 235. The memory controller 212 generates and formats the signals and forwards them to the O/E conversion circuitry 214 and/or the SERDES circuitry 216 for conversion from parallel electrical signals to serialized optical signals and for forwarding on the optical bus 207. The memory controller 212 also receives and processes signals returning from the memory devices 235 via the optical bus 207. In that case, the optical signals are received and converted by the O/E conversion circuitry 214 and/or the SERDES circuitry 216, which forward the converted electrical signals to the memory controller 212 for processing.

Data and control signals to and from the memory devices 235 are routed through and processed by the interface circuitry on the memory modules 230, which includes the SERDES circuitry 229, the O/E conversion circuitry 231 and the electrical buffer circuitry 233. Parallel electrical signals to and from the memory devices 235 are transferred to and from the DRAM memory 237 via the DRAM I/O circuitry 239 and the electrical buffer circuitry 233. The electrical buffer circuitry 233 is coupled to the O/E conversion circuitry 231, which converts incoming optical signals to electrical signals and routes the converted parallel electrical signals to the DRAM I/O circuitry 239 via the electrical buffer circuitry 233. The O/E conversion circuitry 231 also receives parallel electrical signals from the DRAM I/O circuitry 239 via the electrical buffer circuitry 233 and converts them to optical signals. The optical SERDES circuitry 229 receives serialized optical signals from the optical bus 207 and deserializes them and forwards the deserialized signals to the DRAM devices 235 via the O/E conversion circuitry 231 and the electrical buffer circuitry 233. The SERDES circuitry 229 also receives parallel signals from the memory circuits 235 via the electrical buffer circuitry 233 and the O/E conversion circuitry 231, serializes the signals into serialized optical signals, and transfers the serialized optical signal onto the optical bus 207.

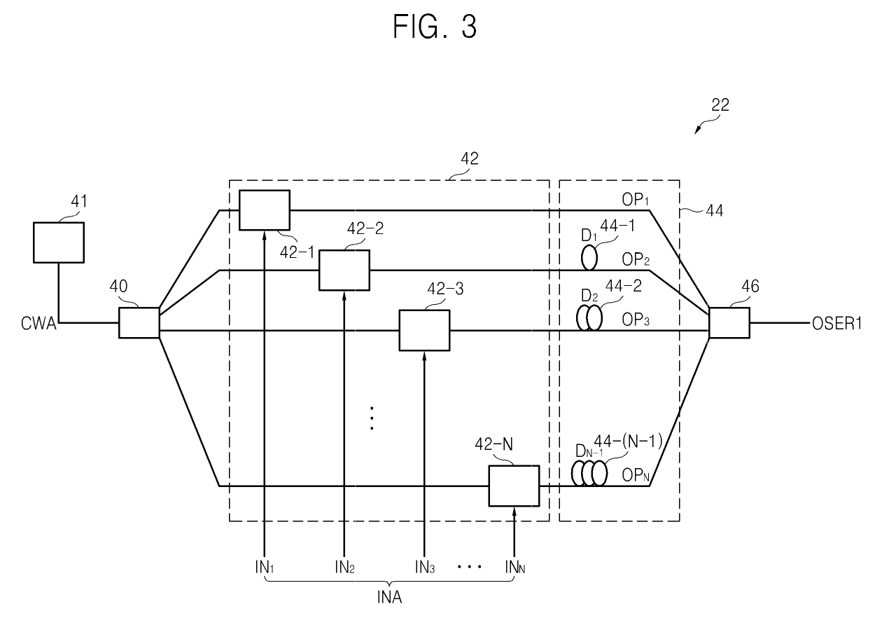

FIG. 3 contains a schematic block diagram of serializer circuitry 22, according to the SERDES circuitry of the inventive concept. The serializer circuitry 22 can be included in SERDES circuitry according to the inventive concept. Referring to FIG. 3, a continuous unmodulated light signal CWA is received from a light source 41, such as a laser diode. A plurality of parallel electrical signals IN₁, IN₂, . . . , IN_{N}, are also received. The continuous unmodulated light signal CWA is applied to an optical splitter 40 which splits the signal CWA into N split continuous unmodulated optical signals, which are applied to a modulation unit 42. The modulation unit 42 includes N modulators 42-1, 42-2, . . . , 42-N, which receive the N split continuous unmodulated optical signals and the N parallel electrical signals IN₁, IN₂, . . . , IN_{N}. The modulators modulate the N split continuous unmodulated optical signals with the N parallel electrical signals IN₁, IN₂, . . . , respectively, to produce N split modulated optical signals, each of which is modulated with the information in a respective one of the N parallel electrical signals IN₁, IN₂, . . . , IN_{N}. That is, the modulators 42-1, 42-2, . . . , 42-N carry out electrical-to-optical conversion on the N parallel electrical signals IN₁, IN₂, . . . , IN_{N}.

The N split modulated optical signals are applied to a delay block 44, which includes a plurality of optical delay units 44-1, 44-2, . . . , 44-N, which may be optical delay lines, each of which receives one of the split modulated optical signals. Each of the delay units 44-1, 44-2, . . . , 44-N is programmed to introduce a predetermined amount of time delay D₁, D₂, . . ., D_{N} into its respective split modulated optical signal, such that the delay block 44 produces a plurality of delayed split modulated optical signals OP₁, OP₂, . . . , OP_{N}. The delayed split modulated optical signals OP₁, OP₂, . . . , OP_{N} are combined by an optical coupler 46 to produce a single optical signal OSER1 which includes a single serialized version of the delayed split modulated optical signals OP₁, OP₂, . . . , OP_{N}. The delays D₁, D₂, . . . , D_{N} are selected such that when the optical coupler 46 combines the delayed split modulated optical signals OP₁, OP₂, . . . , OP_{N}, they are aligned consecutively, and, in one embodiment, contiguously, in time in the single serialized optical signal OSER1 output by the serializer circuitry 22.

It will be noted that, in the embodiment illustrated in FIG. 3, the first split modulated optical signal is not applied to a delay unit in the delay block. The second of the split modulated optical signals is applied to the first delay unit 44-1, the third of the split modulated optical signals is applied to the second delay unit 44-2, etc. This configuration is used as an exemplary illustration only. One of skill in the art would understand that any amount of delay, including the zero delay illustrated in FIG. 3, can be applied to the first split modulated optical signal, as long as all of the delays D₁, D₂, . . . , D_{N} are set such that the delayed split modulated optical signals may be combined by the optical coupler 46 into the single serialized modulated optical signal OSER1 output by the serializer circuitry 22.

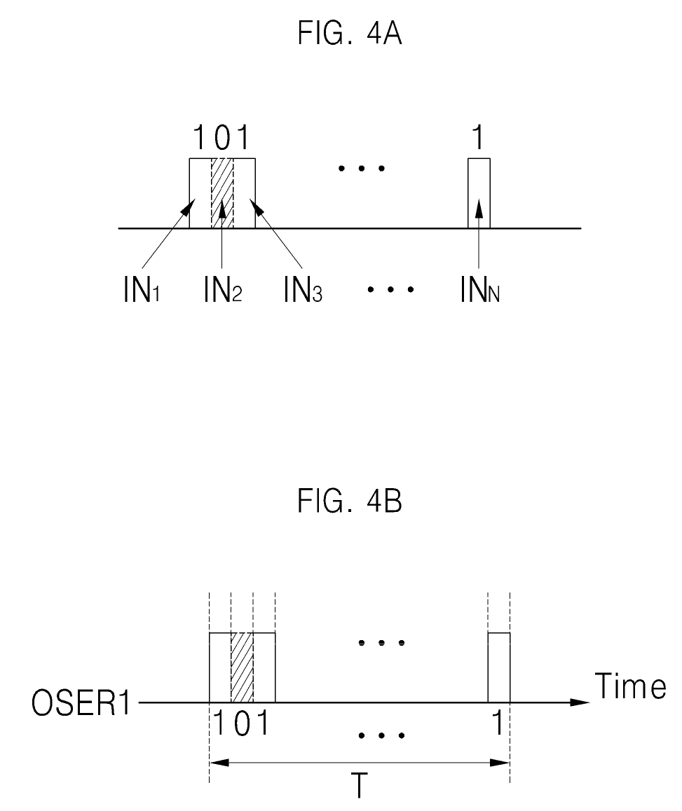

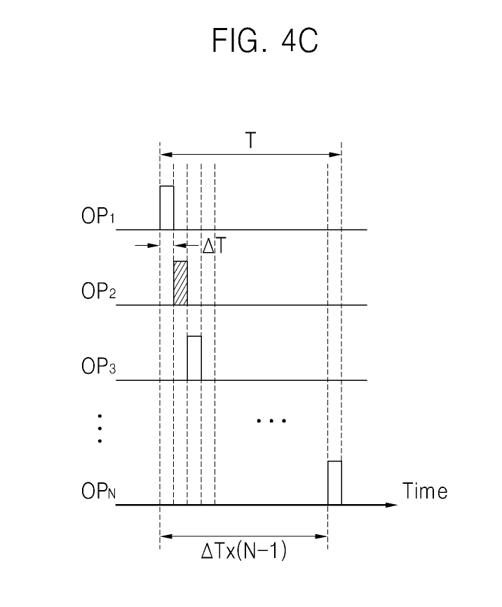

FIGS. 4A through 4C contain schematic diagrams illustrating the serialization process of the serializer circuitry 22 of FIG. 3. Referring to FIG. 4A, an example of the input parallel electrical signals is shown. In this particular example, the input data bits on the parallel electrical signals IN₁, IN₂, IN₃, . . . , IN_{N} are 1, 0, 1, . . . , 1. FIGS. 4B and 4C contain timing diagrams illustrating the timing of the delayed split modulated optical signals OP₁, OP₂, OP₃, . . . , OP_{N}, illustrating that the data for all of the bits occupies a total time period T, and each bit occupies a portion of the total time period T equal to ΔT, where ΔT=T/N. The delays are such that the bit time periods ΔT are consecutive and contiguous as illustrated. Hence, in this illustrated exemplary embodiment, each of the delay units 44-1, 44-2, . . . , 44-N introduces a time delay of ΔT more than its previous adjacent delay unit 44-1, 44-2, . . . , 44-N into its respective split modulated optical signal to produce its respective delayed split modulated optical signal OP₁, OP₂, . . . , OP_{N}. That is, the delay Dᵢ of the delays D₁, D₂, . . . , D_{N} is calculated by Dᵢ=ΔT (i−1), where i=1, 2, . . . , N. Hence, in performing serialization, the serializer circuitry 22 uses the time delays D₁, D₂, . . ., D_{N} to select time slots in the single serialized modulated optical signal OSER1 at which each of the data bits of the delayed split modulated optical signals OP₁, OP₂, . . . , OP_{N} will reside. This “bit slot selection” is also referred to herein as a “switching function.”

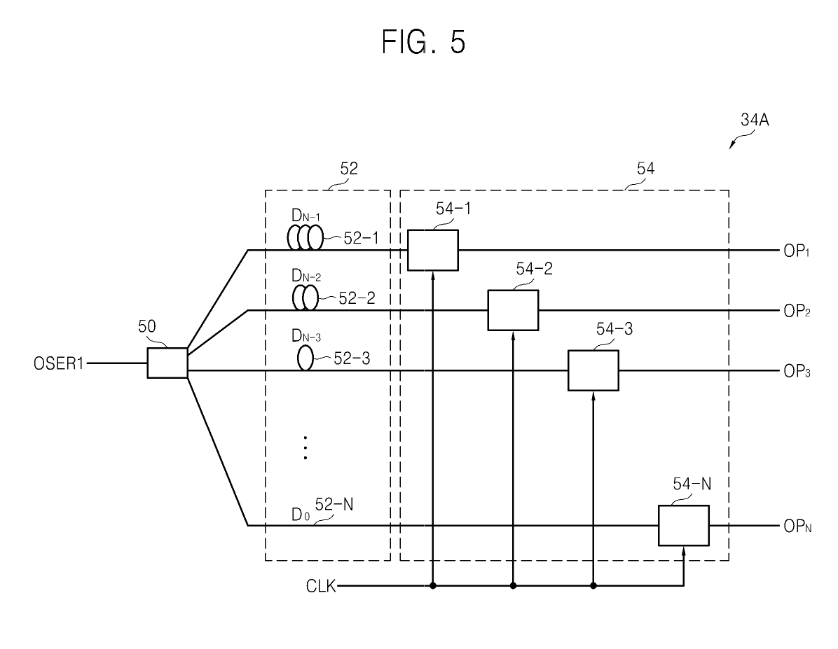

FIG. 5 contains a schematic block diagram of deserializer circuitry 34A, according to the SERDES circuitry of the inventive concept, according to an embodiment of the inventive concept. The deserializer circuitry 34A can be included in SERDES circuitry according to the inventive concept. Referring to FIG. 5, a serialized modulated optical signal OSER1 is received at an optical splitter 50. The optical splitter 50 splits the signal OSER1 into a plurality of split modulated optical signals, which are applied to an optical delay block 52. The optical delay block 52 includes a plurality of delay units 52-1, 52-2, . . . , 52-N, which may be optical delay lines, which introduce delays D_{N-1}, D_{N-2}, . . . , D₀, respectively, into the split modulated optical signals to produce a respective plurality of delayed split modulated optical signals. The delays D_{N-1}, D_{N-2}, . . . , D₀ are selected such that the resulting delayed split modulated optical signals are aligned in time.

The delayed split modulated optical signals are applied to a demodulation unit 54, which includes a plurality of optical demodulators 54-1, 54-2, . . . , 54-N, each of which receives a respective one of the delayed split modulated optical signals. The demodulators 54-1, 54-2, . . . , 54-N can be the same as the modulators 42-1, 42-2, . . . , 42-N in the modulation unit 42 of the embodiment of the serializer circuitry 22 of FIG. 3, and may also perform a switching function. That is, the demodulators 54-1, 54-2, . . . , 54-N in the demodulation unit 54 select a corresponding bit slot in the serialized modulated optical signal OSER1, as illustrated in FIG. 4B. This bit slot selection function can be performed by either the optical demodulators 54-1, 54-2, . . . , 54-N or one or more optical switches. Thus, the “switching function” is a bit slot selection function. The delayed split modulated optical signals output from the delay block 52 can be demodulated or regenerated by the demodulation unit 54. The optical demodulators 54-1, 54-2, . . . , 54-N can demodulate the delayed split modulated optical signals to generate a plurality of delayed split demodulated optical signals OP₁, OP₂, . . . , OP_{N}. The demodulators 54-1, 54-2, . . . , 54-N operate under control of and provide their resulting outputs in response to an applied clock signal CLK. In this embodiment, the CLK signal is applied simultaneously to all of the demodulators 54-1, 54-2, . . . , 54-N.

The delay amounts D_{N-1}, D_{N-2}, . . . , D₀ are selected such that the resulting delayed split demodulated optical signals OP₁, OP₂, . . . , OP_{N} are aligned in time, i.e., are output in parallel. Each delay D_{N-1}, D_{N-2}, . . . , D₀ differs from its next successive adjacent delay by a time ΔT. That is, D_{N-1}=(N-1) ΔT; D_{N-2}=(N-2) ΔT; D_{N-3}=(N-3) ΔT; . . . ; D₀=0.

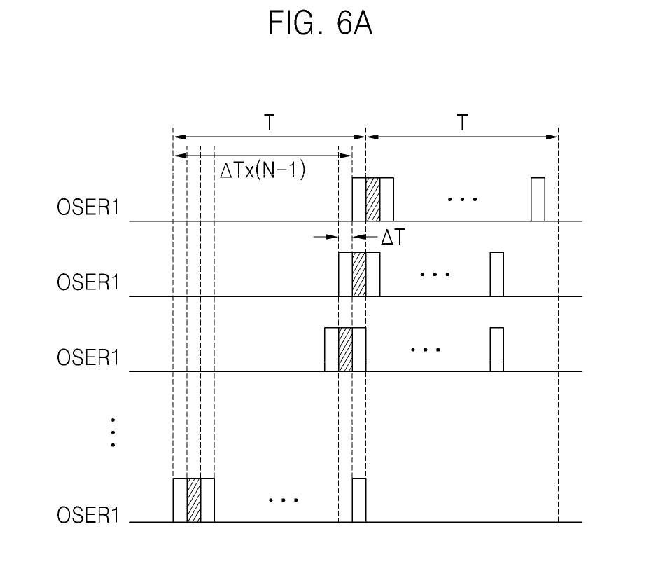

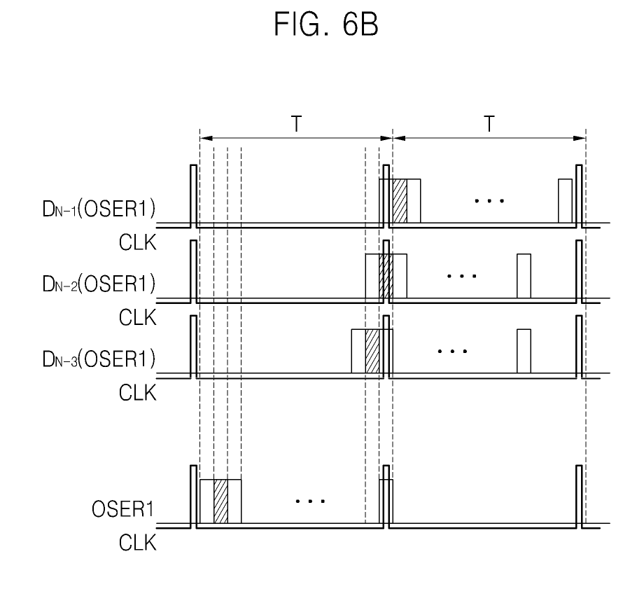

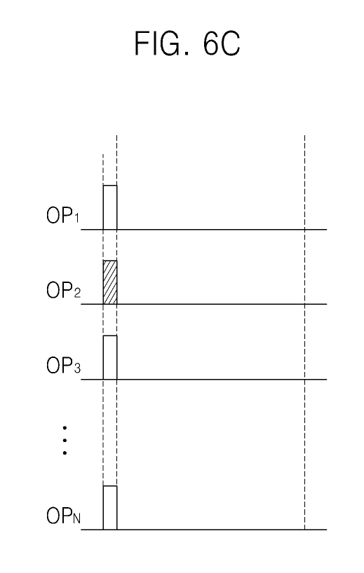

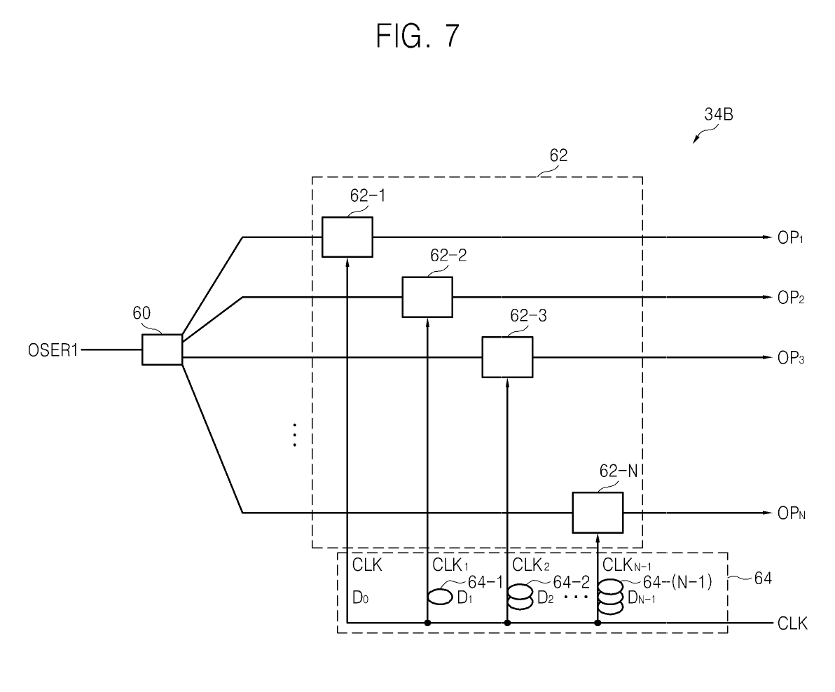

FIGS. 6A through 6C contain schematic diagrams illustrating the deserialization process of the deserializer circuitry 34A of FIG. 5. FIG. 6A illustrates the split serialized modulated optical signals OSER1 as they are received at each delay unit 52-1, 52-2, 52-3, . . . , 52-N of the delay block 52. FIG. 6B illustrates the delayed split serialized modulated optical signals OSER1 after they are delayed by the delay unit 52. As illustrated in FIG. 6B, each of the signals has been delayed a predetermined amount such that the data required to be sampled are aligned in time. At the leading edge of the clock signal CLK, the data bits, which in this example are 1, 0, 1, . . . , 1, are sampled and used to modulate the delayed split output signals OP₁, OP₂, OP₃, . . . , OP_{N} with the correct data. As shown in FIG. 6C, the delayed split output signals OP₁, OP₂, OP₃, . . . , OP_{N} are aligned in time, i.e., in parallel. It should be noted that the demodulators 54-1, 54-2, . . . , 54-N can also be activated on the falling edge of the clock signal CLK, or, in certain systems, can be activated on both edges of the clock signal CLK.

FIG. 7 contains a schematic block diagram of deserializer circuitry 34B, according to the SERDES circuitry of the inventive concept, in accordance with another embodiment of the inventive concept. The deserializer circuitry 34B can be included in SERDES circuitry according to the inventive concept. The embodiment of FIG. 7 is different than the embodiment of FIG. 5 in that, in the embodiment of FIG. 7, instead of delays being introduced into the serialized split modulated optical signals OSER1 received by the demodulation unit, delays are introduced into the clock signal CLK applied to the demodulation unit 62.

Referring to FIG. 7, the serialized modulated optical signal OSER1 is received at an optical splitter 60. The optical splitter 60 splits the signal OSER1 into a plurality of split modulated optical signals, which are applied to a demodulation unit 62, which includes a plurality of optical demodulators 62-1, 62-2, . . . , 62-N, each of which receives a respective one of the plurality of split modulated optical signals. The demodulators 62-1, 62-2, . . . , 62-N can be the same as the modulators 42-1, 42-2, 42-N in the modulation unit 42 of the embodiment of the serializer circuitry 22 of FIG. 3 and may also perform a switching function. That is, the demodulators 62-1, 62-2, . . . , 62-N in the demodulation unit 62 select a corresponding bit slot in the serialized modulated optical signal OSER1, as illustrated in FIG. 4B. This bit slot selection function can be performed by either the optical demodulators 62-1, 62-2, . . . , 62-N or one or more optical switches. Thus, the “switching function” is a bit slot selection function. The split modulated optical signals can be demodulated or regenerated by the demodulation unit 62. The optical demodulators 62-1, 62-2, . . . , 62-N can demodulate the split modulated optical signals to generate a plurality of delayed split demodulated optical signals OP₁, OP₂, . . . , OP_{N}.

The demodulators 62-1, 62-2, . . . , 62-N operate under control of and provide their resulting outputs in response to an applied clock signal CLK. In this embodiment, the CLK signal is applied to a clock signal delay block 64, which includes a plurality of clock signal delay units 64-1, 64-2, . . . , 64-(N-1), each of which introduces a predetermined delay D₁, D₂, . . . , D_{N-1} into its respective clock signal. The clock signal delay block 64 splits the clock signal CLK into a plurality of clock signals, and applies the split clock signals to the delay units 64-1, 64-2, . . . , 64-(N-1) to generate the split delayed clock signals CLK, CLK₁, CLK₂, . . . , CLK_{N-1}. The split delayed clock signals are applied to the demodulators 62-1, 62-1, 62-3, . . . , 62-N, respectively. The delays D₁, D₂, . . . , D_{N-1} are selected such that the resulting split demodulated optical signals OP₁, OP₂, . . . , OP_{N} output by the demodulators 62-1, 62-1, 62-3, . . . , 62-N are aligned in time, i.e., are output in parallel. Each delay D_{N-1}, D_{N-2}, . . . , D₀ differs from its next successive adjacent delay by a time ΔT.

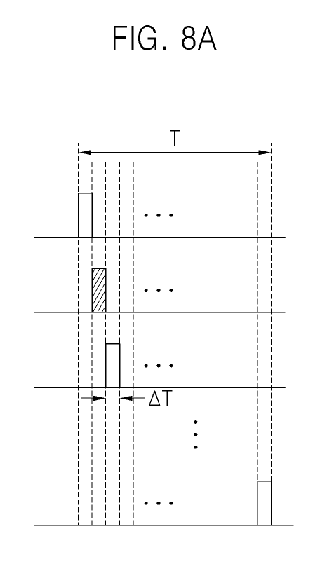

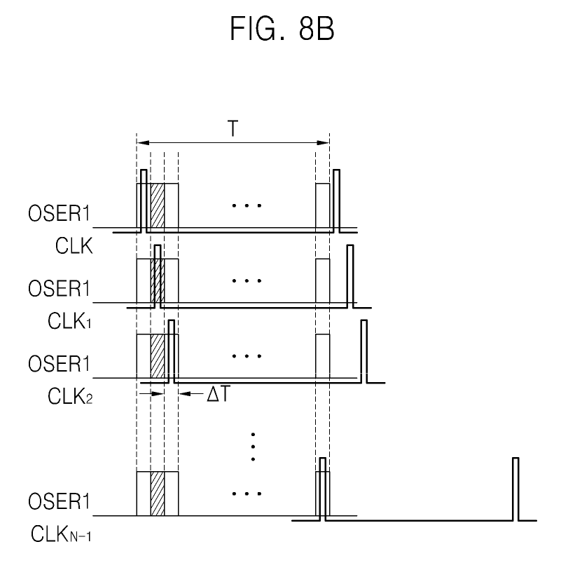

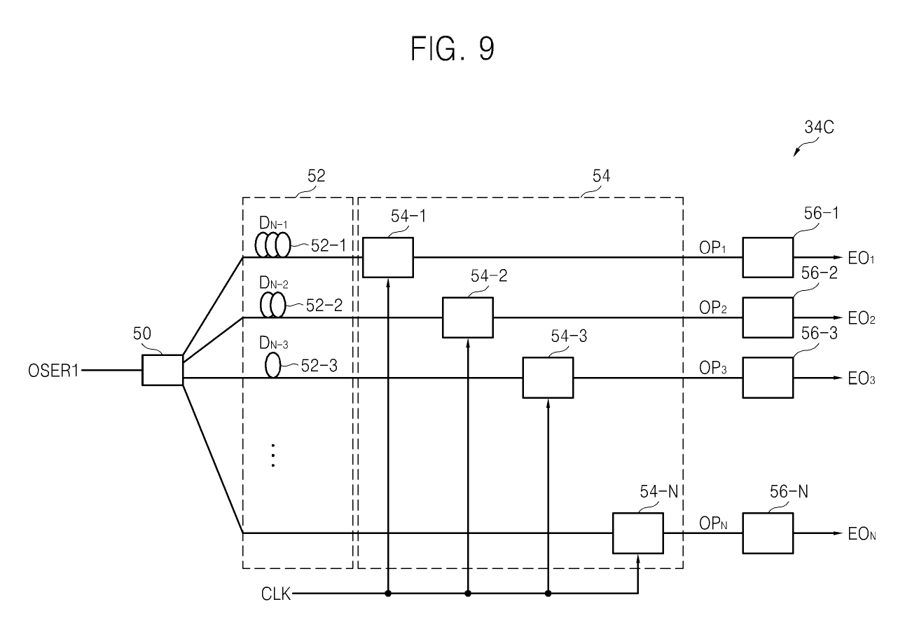

FIGS. 8A and 8B contain schematic diagrams illustrating the deserialization process of the deserializer circuitry 34B of FIG. 7. FIG. 8A illustrates the split serialized modulated optical signals OSER1 as they are received at the demodulation unit 62. The figure illustrates that the time window for each data bit to be sampled to recover the modulated data, e.g., 1, 0, 1, . . . , 1, is shifted in time by an amount ΔT. FIG. 8B illustrates the timing of the delayed split clock signals CLK, CLK₁, CLK₂, . . . , CLK_{N-1} applied to the demodulators 62-1, 62-2, 62-3, . . . , 62-N. FIG. 8B illustrates that, because of the delays in the delayed clock signals CLK, CLK₁, CLK₂, . . . , CLK_{N}, the sampling and recovery of the data and modulation of the output signals OP₁, OP₂, OP₃, . . . , OP_{N} is carried out at sampling windows defined by the delays introduced into the clock signals. That is, the delayed split output signals OP₁, OP₂, OP₃, . . . , OP_{N} are aligned in time, i.e., in parallel. It should be noted that the demodulators 54-1, 54-2, . . . , 54-N can also be activated on the falling edge of the clock signal CLK, or, in certain systems, can be activated on both edges of the clock signal CLK.

FIG. 9 is a schematic block diagram of an embodiment of deserializer circuitry 34C, according to another embodiment of the inventive concept. The embodiment of FIG. 9 is similar to the embodiment of FIG. 5, with the exception of the addition of optical-to-electrical signal conversion at the output of the deserializer 34C. Description of the elements of FIG. 9 that are the same as elements of FIG. 5 will not be repeated.

Referring to FIG. 9, the parallel split demodulated optical signals OP₁, OP₂, OP₃, . . . , OP_{N} are applied to electrical-to-optical conversion circuitry 56-1, 56-2, 56-3, . . . , 56-N, respectively. The electrical-to-optical conversion circuitry 56-1, 56-2, 56-3, . . . , 56-N convert the split demodulated optical signals OP₁, OP₂, OP₃, . . . , OP_{N} to parallel electrical signals EO₁, EO₂, EO₃, . . . , EO_{N}, respectively. The electrical-to-optical conversion circuitry 56-1, 56-2, 56-3, . . . , 56-N can be configured with photodetectors, photodiodes, photo detecting devices, or other similar devices.

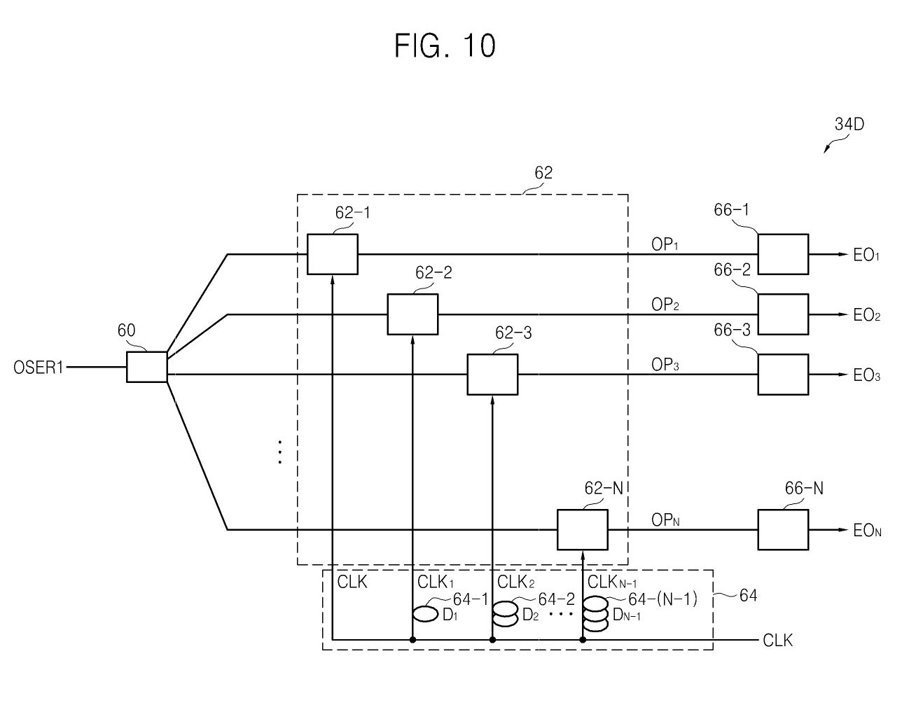

FIG. 10 is a schematic block diagram of an embodiment of deserializer circuitry 34D, according to another embodiment of the inventive concept. The embodiment of FIG. 10 is the same as the embodiment of FIG. 7, with the exception of the addition of optical-to-electrical signal conversion at the output of the deserializer 34D. Description of the elements of FIG. 10 that are the same as elements of FIG. 7 will not be repeated.

Referring to FIG. 10, the parallel split demodulated optical signals OP₁, OP₂, OP₃, . . . , OP_{N} are applied to electrical-to-optical conversion circuitry 66-1, 66-2, 66-3, . . . , 66-N, respectively. The electrical-to-optical conversion circuitry 66-1, 66-2, 66-3, . . . , 66-N convert the split demodulated optical signals OP₁, OP₂, OP₃, . . . , OP_{N} to parallel electrical signals EO₁, EO₂, EO₃, . . . , EO_{N}, respectively. The electrical-to-optical conversion circuitry 66-1, 66-2, 66-3, . . . , 66-N can be configured with photodetectors, photodiodes, photo detecting devices, or other similar devices.

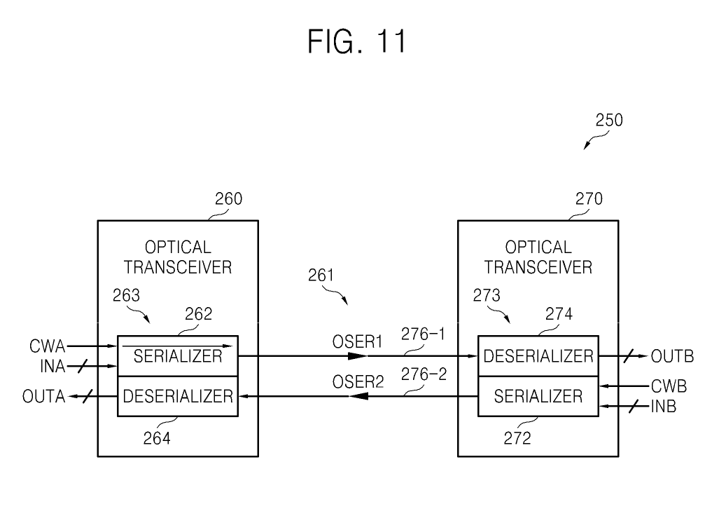

FIG. 11 is a schematic block diagram of a portion of a data processing system to which the optical SERDES according to the inventive concept can be applied. Specifically, FIG. 11 illustrates an optical interconnection system 250 according to an embodiment of the inventive concept used in a data processing system.

Referring to FIG. 11, the data processing system 250 includes two optical transceivers 260 and 270 connected to each other by an optical communication bus or channel 261. The optical bus 261 can be implemented using one or more optical waveguides and/or one or more optical couplers. The optical waveguide(s) can include, for example, glass, polymer, semiconductor or other suitable material. The waveguide(s) may include one or more optical fibers and/or one or more rectangular waveguides suitable for integration in a semiconductor wafer with other circuits, according to silicon photonics technology. The optical transceiver 260 transmits serialized optical signals OSER1 to transceiver 270 on an optical communication line 276-1 of the optical bus 261, and the optical transceiver 270 transmits serialized optical signals OSER2 to transceiver 260 on an optical communication line 276-2 of the optical bus 261.

The optical transceiver 260 includes optical SERDES circuitry 263 according to any of the embodiments of SERDES circuitry described above, and the optical transceiver 270 includes SERDES circuitry 273 according to any of the embodiments of SERDES circuitry described above. The SERDES circuitry 263 includes serializer circuitry 262 and deserializer circuitry 264, and the SERDES circuitry 273 includes serializer circuitry 272 and deserializer circuitry 274. The serializer circuitry 262 and 272 can be of the type described above in connection with embodiments of the inventive concept, and the deserializer circuitry 264 and 274 can be of the type described above in connection with embodiments of the inventive concept.

Using the unmodulated continuous light signal CWA, the serializer circuitry 262 converts input parallel electrical signals INA to a serialized optical signal OSER1 for transfer on the optical bus 276-1. Using the unmodulated continuous light signal CWB, the serializer circuitry 272 converts input parallel electrical signals INB to a serialized optical signal OSER2 for transfer on the optical bus 276-2. The deserializer 264 converts the serialized optical signal OSER2 received from the optical bus 276-2 to parallel electrical signals OUTA, and the deserializer 274 converts the serialized optical signal OSER1 received from the optical bus 276-1 to parallel electrical signals OUTB.

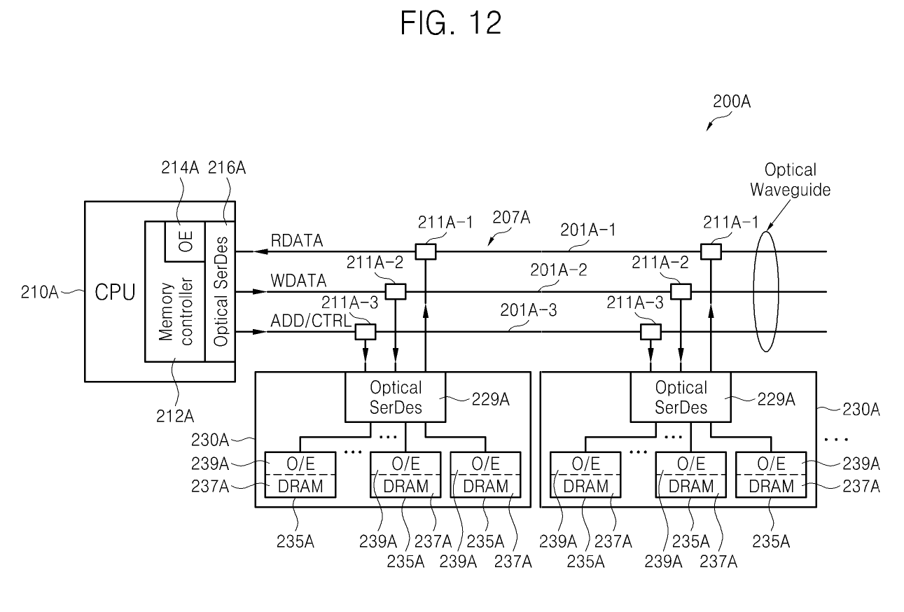

FIG. 12 contains a schematic functional block diagram of a processing system 200A according to an exemplary embodiment of the inventive concept, which uses optical SERDES according to the inventive concept to convert between parallel and serial signal communication formats. The processing system of FIG. 12 is similar to the processing system 200 illustrated in and described above in connection with FIG. 2, with the exception that, in the processing system 200A of FIG. 12, the DRAM memory circuits 235A of FIG. 12 include the O/E conversion circuitry 239A integrated on the DRAM memory chip instead of as circuitry separate from the DRAM memory circuits.

Referring to FIG. 12, the illustrative exemplary embodiment of the processing system 200A is a DRAM interface (I/F) system, which processes data to and from DRAM memory circuits. It should be noted that this exemplary embodiment of the inventive concept is for illustration purposes. As described herein in detail, the inventive concept is applicable to other types of systems.

Referring to FIG. 12, the system 200A includes a processing system 210A, e.g., a CPU, which is coupled to a plurality of memory modules 230A via an optical bus 207A. The optical bus 207A is shown to include three optical lines 201A-1, 201A-2, and 201A-3, which can be implemented as one or more optical waveguides. The lines 201A-1, 201A-2, and 201A-3 are coupled between the memory modules 230A and the processing system 210A by optical couplers 211A-1, 211A-2, and 211A-3. In one particular embodiment, such as the DRAM I/F embodiment illustrated in FIG. 12, one of the lines 201A-1 is a read data RDATA line, one of the lines 201A-2 is a write data WDATA line, and one of the lines 201A-3 is an address/control ADD/CTRL line. In each line, the information to be transmitted over the bus 207A is in serialized format and is transmitted optically.

Each of the memory modules 230A includes interface circuitry, which includes the optical SERDES circuitry 229A. Each DRAM circuit 235a includes DRAM memory 237A and DRAM optical-to-electrical and electrical-to-optical conversion (O/E) circuitry 239A. The processing system 210A also includes interface circuitry, which includes a memory controller 212A, the optical SERDES circuitry 216A, and optical-to-electrical and electrical-to-optical conversion (O/E) circuitry 214A.

In the system 200A, data and control signals are transferred back and forth between the processing system 210A and the memory modules 235A under the control of the memory controller 212A. The memory controller 212A generates all of the timing and control signals required to implement data read operations for reading data from the memory devices 235A, data write operations for writing data to the memory devices 235A, and any other operations to be performed by the memory devices 235A. The memory controller 212A generates and formats the signals and forwards them to the O/E conversion circuitry 214A and/or the SERDES circuitry 216A for conversion from parallel electrical signals to serialized optical signals and for forwarding on the optical bus 207A. The memory controller 212A also receives and processes signals returning from the memory devices 235A via the optical bus 207A. In that case, the optical signals are received and converted by the O/E conversion circuitry 214A and/or the SERDES circuitry 216A, which forward the converted electrical signals to the memory controller 212A for processing.

Data and control signals to and from the memory devices 235A are routed through and processed by the SERDES circuitry 229A and the O/E conversion circuitry 239A. The O/E conversion circuitry 239A converts incoming optical signals to electrical signals and routes the converted parallel electrical signals to the DRAM 237A. The O/E conversion circuitry 239A also receives parallel electrical signals from the DRAM 237A and converts them to optical signals. The optical SERDES circuitry 229A receives serialized optical signals from the optical bus 207A and deserializes them and forwards the deserialized signals to the DRAM devices 235A, in particular, the O/E conversion circuitry 239A on the DRAM circuits 235A. The SERDES circuitry 229a also receives parallel signals from the memory circuits 235A via the O/E conversion circuitry 239A, serializes the signals into serialized optical signals, and transfers the serialized optical signal onto the optical bus 207A.

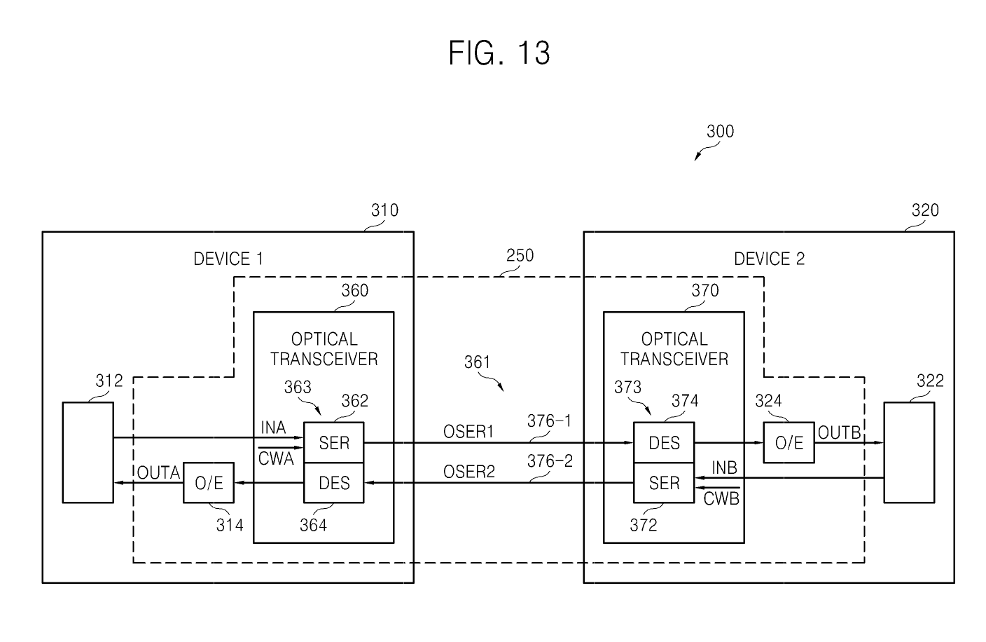

FIG. 13 contains a schematic block diagram of a processing system 300 to which the optical SERDES according to the inventive concept can be applied, according to an embodiment of the inventive concept. The processing system 300 of FIG. 13 includes the optical interconnection system 250 of the type illustrated in and described above in connection with FIG. 11. Two processing systems 310 and 320, referred to as Device 1 and Device 2, communicate via the optical interconnection system 250.

Referring to FIG. 13, the interconnection system 250 of the data processing system 300 includes two optical transceivers 360 and 370 connected to each other by an optical communication bus or channel 361. The optical bus 361 can be implemented using one or more optical waveguides and/or one or more optical couplers.

The optical waveguide(s) can include, for example, glass, polymer, semiconductor or other suitable material. The waveguide(s) may include one or more optical fibers and/or one or more rectangular waveguides suitable for integration in a semiconductor wafer with other circuits, according to silicon photonics technology. The optical transceiver 360 transmits serialized optical signals OSER1 to transceiver 370 on an optical communication line 376-1 of the optical bus 361, and the optical transceiver 370 transmits serialized optical signals OSER2 to transceiver 360 on an optical communication line 376-2 of the optical bus 361.

The optical transceiver 360 includes optical SERDES circuitry 363 according to any of the embodiments of SERDES circuitry described above, and the optical transceiver 370 includes SERDES circuitry 373 according to any of the embodiments of SERDES circuitry described above. The SERDES circuitry 363 includes serializer circuitry 362 and deserializer circuitry 364, and the SERDES circuitry 373 includes serializer circuitry 372 and deserializer circuitry 374. The serializer circuitry 362 and 372 can be of the type described above in connection with embodiments of the inventive concept such as, for example, the serializer circuitry 22 illustrated in and described in connection with FIG. 3; and the deserializer circuitry 364 and 374 can be of the type described above in connection with embodiments of the inventive concept, such as, for example, the deserializer circuitry 34A and 34B illustrated in and described in connection with FIGS. 5 and 7, respectively.

Using the unmodulated continuous light signal CWA, the serializer circuitry 362 converts input parallel electrical signals INA received from the processing device such as microprocessor 312 to a serialized optical signal OSER1 for transfer on the optical bus 376-1. Using the unmodulated continuous light signal CWB, the serializer circuitry 372 converts input parallel electrical signals INB received from the processing device such as microprocessor 322 to a serialized optical signal OSER2 for transfer on the optical bus 376-2. The deserializer 364 converts the serialized optical signal OSER2 received from the optical bus 376-2 to parallel optical signals, which are converted to parallel electrical signals OUTA by O/E conversion circuitry 314. The converted parallel electrical signals are routed to the microprocessor 312. The deserializer 374 converts the serialized optical signal OSER1 received from the optical bus 376-1 to parallel optical signals, which are converted to parallel electrical signals OUTB by O/E conversion circuitry 324. The converted parallel electrical signals are routed to the microprocessor 322.

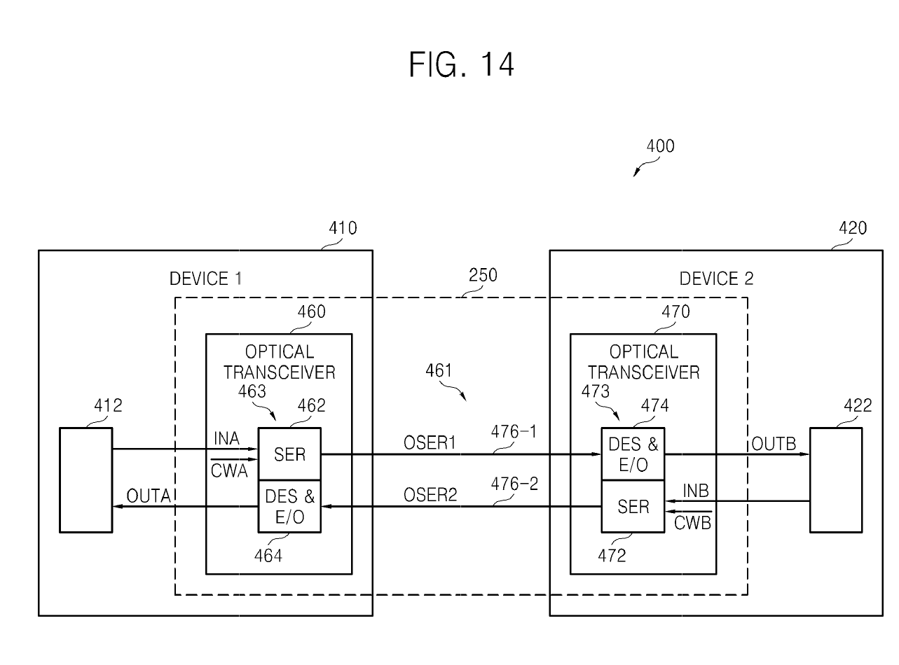

FIG. 14 contains a schematic block diagram of a processing system 400 to which the optical SERDES according to the inventive concept can be applied, according to an embodiment of the inventive concept. The processing system 400 of FIG. 13 includes the optical interconnection system 250 of the type illustrated in and described above in connection with FIG. 11. Two processing systems 410 and 420, referred to as Device 1 and Device 2, communicate via the optical interconnection system 250.

Referring to FIG. 14, the interconnection system 250 of the data processing system 400 includes two optical transceivers 460 and 470 connected to each other by an optical communication bus or channel 461. The optical bus 461 can be implemented using one or more optical waveguides and/or one or more optical couplers. The optical waveguide(s) can include, for example, glass, polymer, semiconductor or other suitable material. The waveguide(s) may include one or more optical fibers and/or one or more rectangular waveguides suitable for integration in a semiconductor wafer with other circuits, according to silicon photonics technology. The optical transceiver 460 transmits serialized optical signals OSER1 to transceiver 470 on an optical communication line 476-1 of the optical bus 461, and the optical transceiver 470 transmits serialized optical signals OSER2 to transceiver 460 on an optical communication line 476-2 of the optical bus 461.

The optical transceiver 460 includes optical SERDES circuitry 463 according to any of the embodiments of SERDES circuitry described above, and the optical transceiver 470 includes SERDES circuitry 473 according to any of the embodiments of SERDES circuitry described above. The SERDES circuitry 463 includes serializer circuitry 462 and deserializer circuitry 464, and the SERDES circuitry 473 includes serializer circuitry 472 and deserializer circuitry 474. The serializer circuitry 462 and 472 can be of the type described above in connection with embodiments of the inventive concept such as, for example, the serializer circuitry 22 illustrated in and described in connection with FIG. 3; and the deserializer circuitry 464 and 474 can be of the type described above in connection with embodiments of the inventive concept, such as, for example, the deserializer circuitry 34C and 34D illustrated in and described in connection with FIGS. 9 and 10, respectively. Specifically, the difference between the deserializers 464 and 474 of the embodiment of FIG. 14 and the deserializers 364 and 374 of the embodiment of FIG. 13 is that the deserializers 464 and 474 of FIG. 14 include the E/O conversion circuitry, and the deserializers 364 and 374 of FIG. 13 provide their outputs to separate E/O conversion circuitry 314 and 324, respectively.

Referring again to FIG. 14, using the unmodulated continuous light signal CWA, the serializer circuitry 462 converts input parallel electrical signals INA received from the processing device such as microprocessor 412 to a serialized optical signal OSER1 for transfer on the optical bus 476-1. Using the unmodulated continuous light signal CWB, the serializer circuitry 472 converts input parallel electrical signals INB received from the processing device such as microprocessor 422 to a serialized optical signal OSER2 for transfer on the optical bus 476-2. The deserializer 464 converts the serialized optical signal OSER2 received from the optical bus 476-2 to parallel optical signals, which are converted to parallel electrical signals OUTA by O/E conversion circuitry within the deserializer 464. The converted parallel electrical signals are routed to the microprocessor 412. The deserializer 474 converts the serialized optical signal OSER1 received from the optical bus 476-1 to parallel optical signals, which are converted to parallel electrical signals OUTB by O/E conversion circuitry within the deserializer 474. The converted parallel electrical signals are routed to the microprocessor 422.

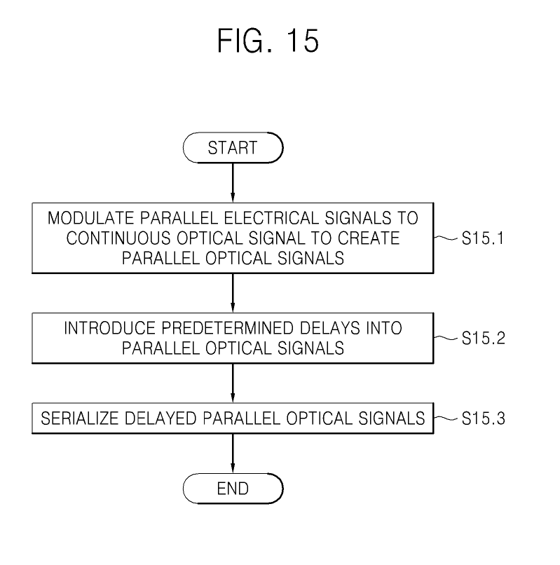

FIG. 15 is a schematic flow diagram illustrating a method of converting a plurality of parallel electrical signals into a serialized optical signal, according to an embodiment of the inventive concept. The serializing method of FIG. 15 can be carried out by, for example, the serializer circuitry 22 of FIG. 3.

Referring to FIG. 15, a continuous optical signal is split and modulated by a plurality of parallel electrical signals to generate a plurality of parallel optical signals in step S15.1. In step S15.2, predetermined delays are introduced into the parallel optical signals. In step S 15.3, the delayed parallel optical signals are combined to form a serialized optical signal.

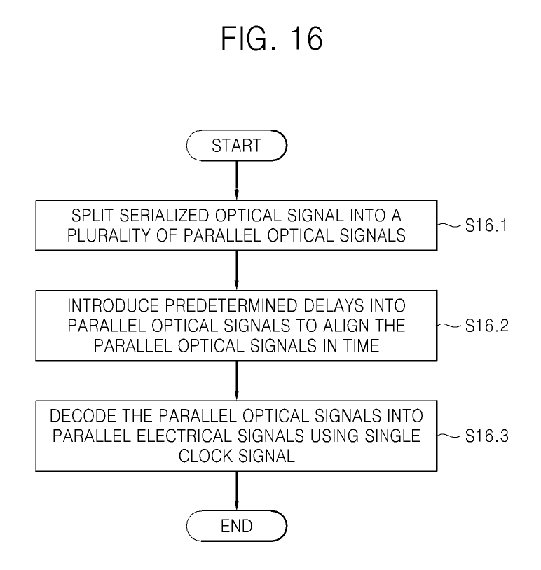

FIG. 16 is a schematic flow diagram illustrating a method of converting a serialized optical signal to a plurality of parallel electrical signals, according to an embodiment of the inventive concept. The deserializing method of FIG. 16 can be carried out by, for example, the deserializer circuitry 34A of FIG. 5 or the deserializer circuitry 34C of FIG. 9.

Referring to FIG. 16, a serialized optical signal is split into a plurality of parallel optical signals in step S16.1. In step S16.2, predetermined delays are introduced into the parallel optical signals to align the parallel optical signals in time. In step S16.3, the parallel optical signals are decoded or demodulated into parallel electrical signals using a single clock signal.

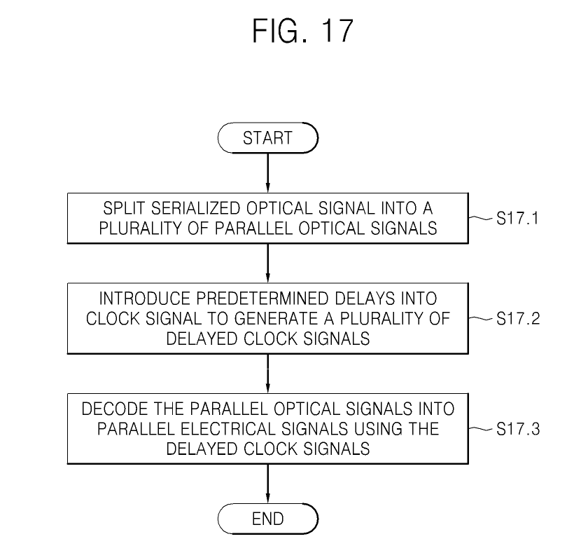

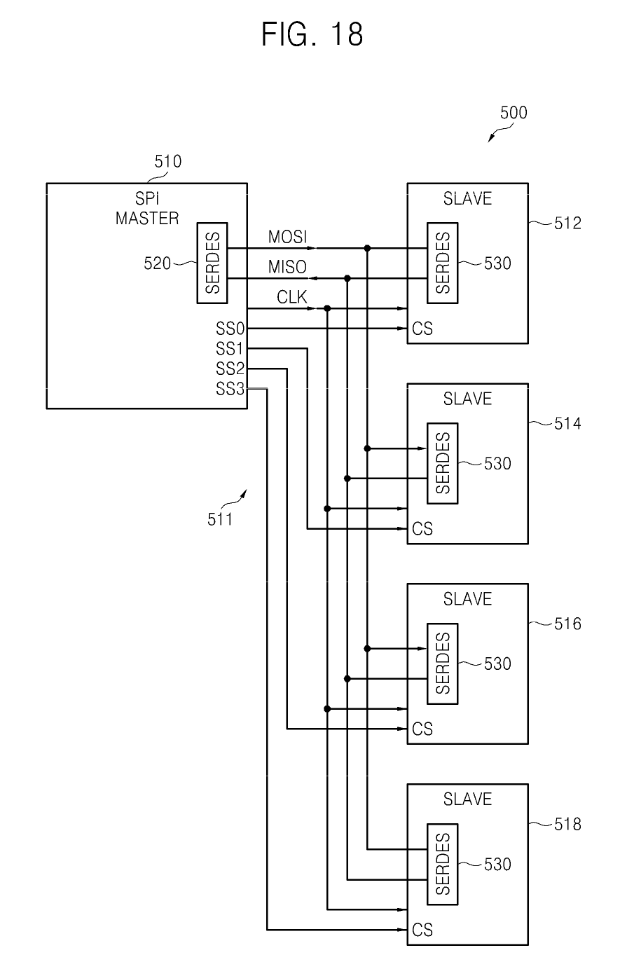

FIG. 17 is a schematic flow diagram illustrating a method of converting a serialized optical signal to a plurality of parallel electrical signals, according to an embodiment of the inventive concept. The deserializing method of FIG. 17 can be carried out by, for example, the deserializer circuitry 34B of FIG. 7 or the deserializer circuitry 34D of FIG. 10.

Referring to FIG. 17, a serialized optical signal is split into a plurality of parallel optical signals in step S17.1. In step S17.2, predetermined delays are introduced into a clock signal to generate a plurality of delayed clock signals. In step S17.3, the parallel optical signals are decoded or demodulated into parallel electrical signals using the plurality of delayed clock signals.

In the processing systems 300 and 400 of FIGS. 13 and 14, the devices 310, 320 and 410, 420 communicate using a serial communication protocol for transferring and receiving data and signals. The inventive concept is applicable to many types of serial communication protocols that are currently in use and are under development. For example, the inventive concept is applicable to serial communication protocols such as Universal Asynchronous Receiver Transmitter (UART), Serial Peripheral Interface (SPI), Serial Advanced Technology Attachment (SATA), Inter-Integrated Circuit (I²C), System Management Bus (SMB), Controller Area Network (CAN), Universal Serial Bus (USB), Peripheral Component Internet Express (PCI-E), Mobile Industry Processor Interface (MIPI), Light Peak, and other known serial communication protocols.

FIG. 18 is a schematic block diagram of a data processing system 500 in which SPI serial communication, using the SERDES circuitry of the inventive concept, is used. Conventional SPI serial communication protocol is known in the art. Description of the conventional SPI serial communication protocol can be found on the Internet at, for example, http://en.wikipedia.org/wiki/Serial_Peripheral_Interface_Bus, and references cited therein, the entire contents of which are incorporated herein by reference.

Referring to FIG. 18, the SPI system 500 according to the inventive concept includes an SPI master device 510 coupled to and communicating with a plurality, four, for example, slave devices 512, 514, 516, 518, via a serial optical interconnection system 511. Each of the slave devices 512, 514, 516, 518 can be a shift register, memory chip or device, port expander, display driver, data converter, printer, data storage device, sensor, microprocessor or other such device. Each of the devices 510, 512, 514, 516 and 518 includes an optical communication interface, which includes an optical interface, which can include the SERDES circuitry 520, 530 according to the inventive concept. The optical interfaces having the SERDES circuitry 520, 530 can transfer serialized optical signals via the master out-slave in (MOSI) or master in-slave out (MISO) optical lines. The interfaces 520, 530 can transfer serial clock signals CLK between the interfaces 520, 530 via electrical and/or optical data buses. Each of the SPI slave devices 512, 514, 516, 518 can be selected by a corresponding chip select signal SS0, SS1, SS2, SS3 via a corresponding chip select input CS via a communication bus which can be configured as an electrical and/or optical bus.

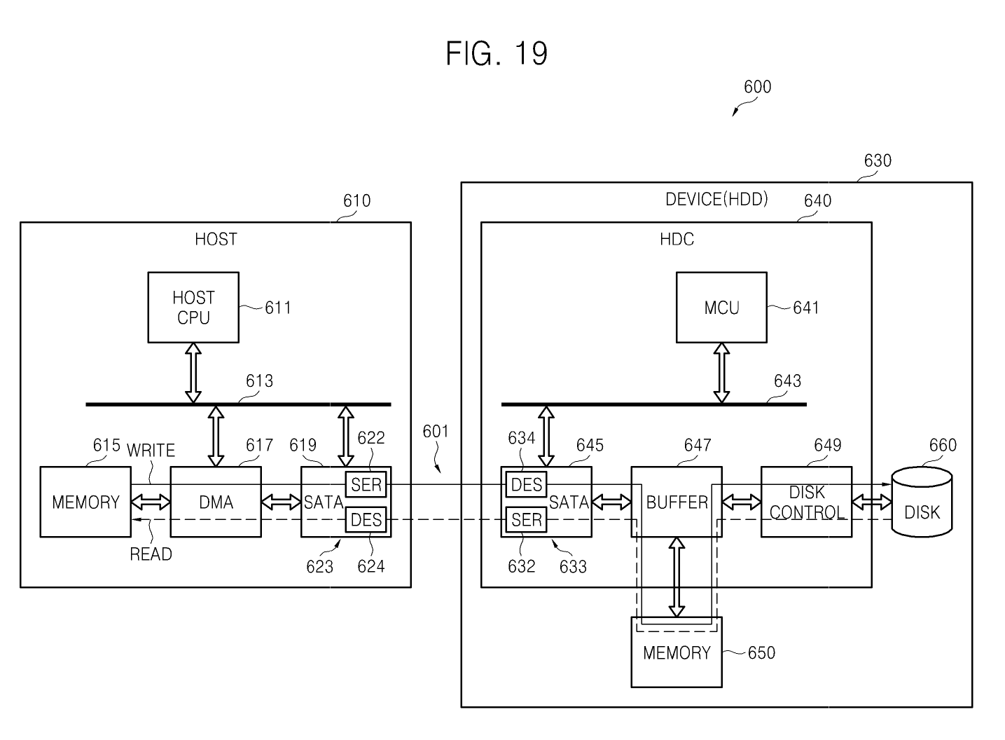

FIG. 19 is a schematic block diagram of a data processing system 600 in which SATA serial communication, using the SERDES circuitry of the inventive concept, is used. Conventional SATA serial communication protocol is known in the art. Description of the conventional SATA serial communication protocol can be found on the Internet at, for example, http://en.wikipedia.org/wiki/Serial_ATA, and references cited therein, the entire contents of which are incorporated herein by reference.

Referring to FIG. 19, the SATA system 600 according to the inventive concept includes a SATA host 610 coupled to and communicating with a SATA device 630 via a serial optical interconnection system 608. The host device 610 includes a host CPU 611 communicating via a data bus 613. The host device also 610 also includes a direct memory access (DMA) controller 617 which is also coupled to the data bus 613 and which controls direct access to a memory 615. The DMA controller 617 also communicates with a SATA interface device 619. The SATA interface device 619 includes the SERDES circuitry 623 of the inventive concept, which includes the serializer circuitry 622 of the inventive concept and the deserializer circuitry 624 of the inventive concept.

The SATA device 630 of the SATA system 600 includes a hard disk controller (HDC) 640 coupled to a memory system such as a hard disk 660 and a memory 650. The HDC 640 includes a main control unit 641 communicating via a data bus 643. The HDC 640 also includes a disk control 649 coupled between the disk 660 and a buffer 647. A SATA interface device is also coupled to the buffer 647. The buffer 647 buffers signals between the disk control 649, the memory 650 and the SATA interface device 645. The SATA interface device 645 includes The SERDES circuitry 633 of the inventive concept, which includes the serializer circuitry 632 of the inventive concept and the deserializer circuitry 634 of the inventive concept. The serializer circuitry 622 and the deserializer circuitry 624 of the SATA interface device 619 implement serial optical communication over the serial optical interconnection system 608 with the serializer circuitry 632 and the deserializer circuitry 634 of the HDC 640, according to the descriptions of the embodiments of the inventive concept contained herein.

The HDC 640 controls at least one of the MCU 641, data bus 643, SATA interface device 645, buffer 647 and disk control 649. During a write operation, write data stored in memory 615 may be transferred to the serializer 622 of the SATA interface device 619 under the control of the DMA controller 617. The serializer 622 serializes the parallel electrical write data to optical serial data, according to the inventive concept, and transfers the data to deserializer 634. The deserializer 634 deserializes the serialized optical data to parallel optical data using an electrical clock signal and converts the parallel optical data to electrical parallel electrical signals, according to the inventive concept. The buffer 647 temporarily buffers/stores the parallel electrical data signals and transfers them to memory 650. The disk control 649 reads the data stored in the memory 650 and writes the data to the disk 660. It should be noted that the disk 660 can be a hard disk drive (HDD), a solid-state drive (SSD) or other type of mass storage device. During a read operation, the process is essentially the process described above in reverse.

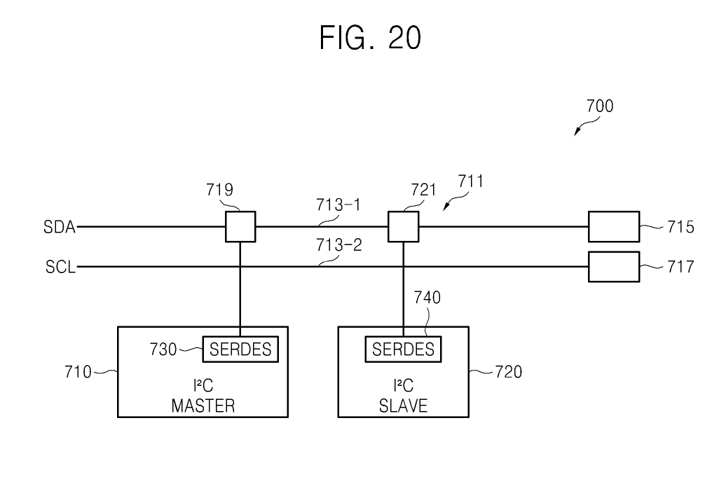

FIG. 20 is a schematic block diagram of a data processing system 700 in which I²C serial communication, using the SERDES circuitry of the inventive concept, is used. Conventional I²C serial communication protocol is known in the art. Description of the conventional I²C serial communication protocol can be found on the Internet at, for example, http://en.wikipedia.org/wiki/I%C2%B2C, and references cited therein, the entire contents of which are incorporated herein by reference.

Referring to FIG. 20, the I²C system 700 according to the inventive concept includes an I²C master device 710 and an I²C slave device 720, which communicate serially over an optical serial bus 711, which includes optical bus lines 713-1 and 713-2. The master device 710 and slave device 720 are connected to each other via the serial data line SDA 713-1 of optical serial bus 711 by optical power splitting or coupling components 719 and 721, respectively, as shown. The serial data line SDA 713-1 and serial clock line SCL 713-2 of the optical serial bus 711 are terminated by optical termination devices 715 and 717, respectively, to eliminate reflection of optical signals resulting from the abrupt index change at the end facets of the optical bus lines.

Each of the I²C master device 710 and the I²C slave device 720 includes an interface device 730 and 740, respectively, which includes the SERDES circuitry of the inventive concept described herein. The master device 710 and slave device 720 communicate serially by transferring serial optical signals over the optical bus 711 using the SERDES circuitry 730 and 740, respectively, according to the detailed description contained herein. Optical signals serialized by the serializer circuitry in SERDES circuitry 730 in the master device 710 are transferred to the SERDES circuitry 740 in the slave device 720 through the serial data line SDA 713-1, and are then deserialized into parallel electrical signals by the deserializer of SERDES 740. Optical signals serialized by the serializer circuitry in SERDES circuitry 740 in the slave device 720 are transferred to the SERDES circuitry 730 in the master device 710 through the serial data line SDA 713-1, and are then deserialized into parallel electrical signals by the deserializer of SERDES 730. A serial clock signal used to transfer serialized optical signals is transferred between the slave device 710 and the master device 720 over the serial clock line SCL 713-2.

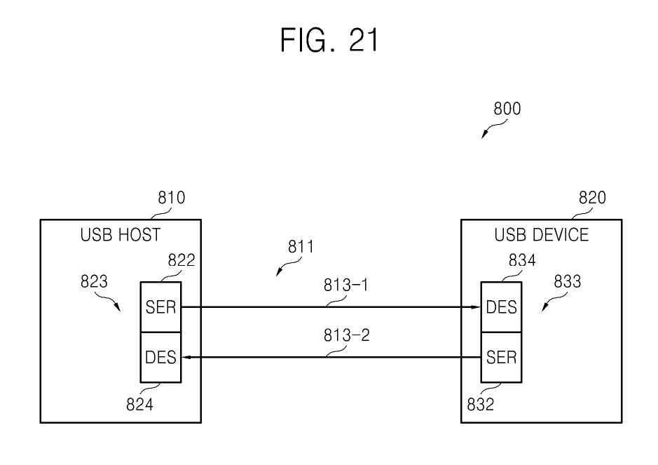

FIG. 21 is a schematic block diagram of a data processing system 800 in which USB serial communication, using the SERDES circuitry of the inventive concept, is used. Conventional USB serial communication protocol is known in the art. Description of the conventional USB serial communication protocol can be found on the Internet at, for example, http://en.wikipedia.org/wiki/I%C2%B2C, and references cited therein, the entire contents of which are incorporated herein by reference. The inventive concept is applicable to all versions of USB serial communication, including, at least, versions 1.0, 2.0 and 3.0.

Referring to FIG. 21, the USB system 800 according to the inventive concept includes a USB host device 810 and a USB device 820, which communicate serially over an optical serial bus 811, which includes bus lines 813-1 and 813-2.

Each of the USB host device 810 and USB device 820 includes an interface device 823 and 833, respectively, which includes the SERDES circuitry of the inventive concept described herein. The USB host device 810 and USB device 820 communicate serially by transferring optical serial signals over the bus 811 using the SERDES circuitry 823 and 833 respectively, according to the detailed description contained herein. Signals serialized by the serializer circuitry 822 in SERDES circuitry 823 in the host device 810 are transferred to the SERDES circuitry 833 in the USB device 820 through the serial data line 813-1, and are then deserialized into parallel electrical signals by the deserializer 834 of SERDES circuitry 833. Signals serialized by the serializer circuitry 832 in SERDES circuitry 833 in the USB device 820 are transferred to the SERDES circuitry 823 in the host device 810 through the serial data line 813-2, and are then deserialized into parallel electrical signals by the deserializer 824 of SERDES 823.

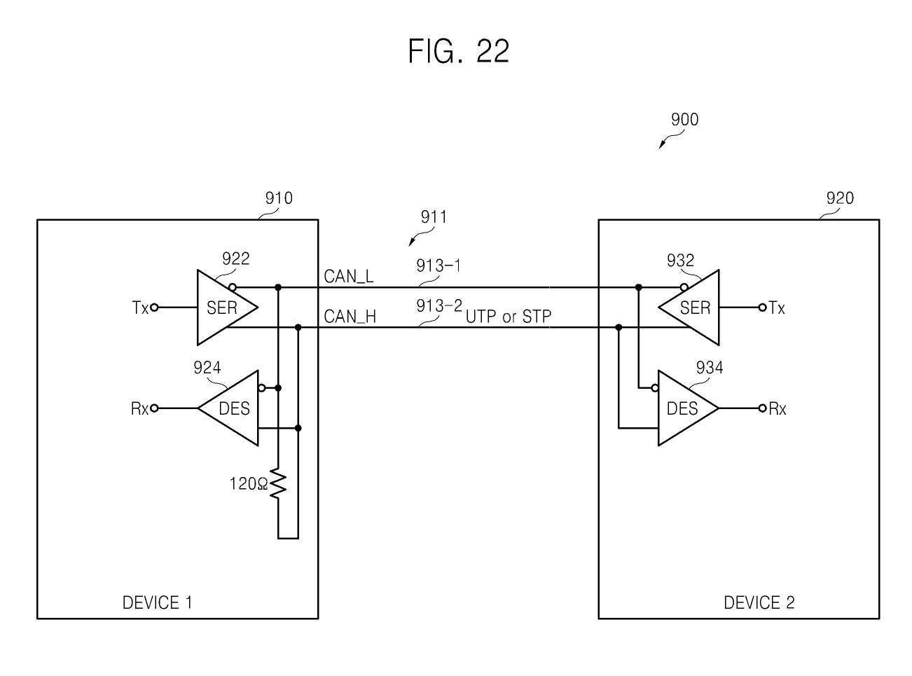

FIG. 22 is a schematic block diagram of a data processing system 900 in which controller area network (CAN) serial communication, using the SERDES circuitry of the inventive concept, is used. Conventional CAN serial communication protocol is known in the art. Description of the conventional CAN serial communication protocol can be found on the Internet at, for example, http://en.wikipedia.org/wiki/Controller_area_network, and references cited therein, the entire contents of which are incorporated herein by reference.

Referring to FIG. 22, the CAN system 900 according to the inventive concept includes a first device 910, referred to as Device 1, and a second device 920, referred to as Device 2, which communicate serially over an optical serial bus 911, which includes optical bus lines 913-1 and 913-2. Device 1 910 can be a microcontroller or other similar device. Bus lines 913-1 and 913-2 can be implemented as a shielded twisted pair (STP) or unshielded twisted pair (UTP). The signals CAN_L and CAN_H, carried on bus lines 913-1 and 913-2, respectively, can be differential signals, across an impedance of, for example, 120Ω.

Each of Device 1 910 and Device 2 920 includes interface circuitry, which includes the SERDES circuitry of the inventive concept described herein. Device 1 910 and Device 2 920 communicate serially by transferring serial signals over the bus 911 using the SERDES circuitry according to the detailed description contained herein. Signals serialized by the serializer circuitry 922 in Device 1 910 are transferred to the SERDES circuitry in Device 2 920 through the serial bus lines 913-1 and 913-2, and are then deserialized into parallel electrical signals by the deserializer 934 of the SERDES circuitry in Device 2 920. Signals serialized by the serializer circuitry 932 in the SERDES circuitry in Device 2 920 are transferred to the SERDES circuitry in Device 1 910 through the serial bus lines 913-1 and 913-2, and are then deserialized into parallel electrical signals by the deserializer 924 of the SERDES circuitry in Device 1 910.

As noted above, the inventive concept is applicable to any form of serial communication protocols defined or maintained by and/or associated with the Mobile Industry Processor Interface (MIPI) Alliance. Information and specifications for serial communication protocols according to the MIPI Alliance can be found on the Internet at http://www.mipi.org/aoverview.shtml and at http://en.wikipedia.org/wiki/Mobile_Industry_Processor_Interface, and references cited therein, the entire contents of which are incorporated herein by reference.

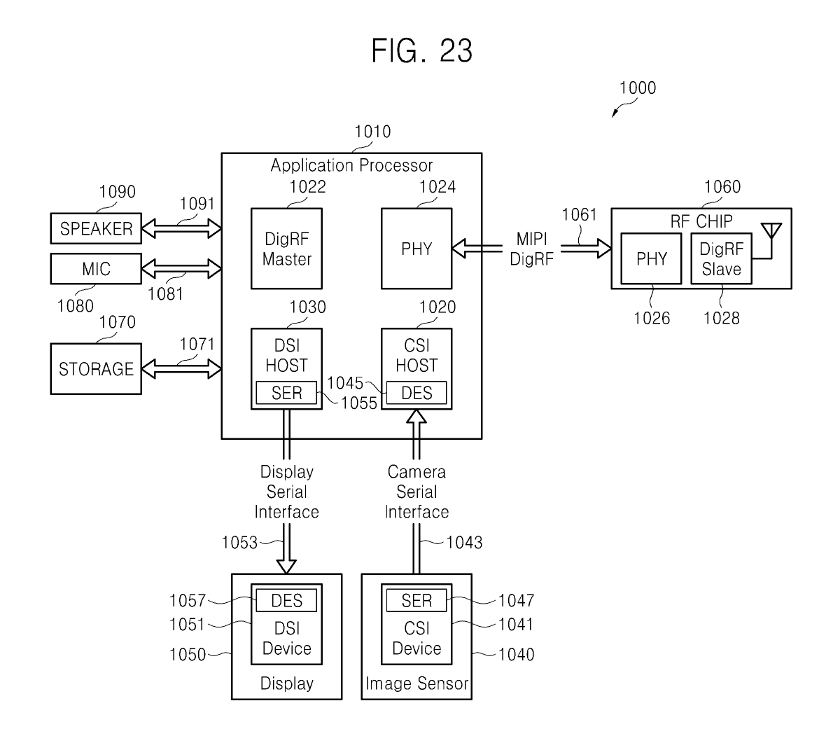

FIG. 23 is a schematic block diagram of a system 1000, which uses a plurality of serial communication interfaces which are maintained by the MIPI Alliance, and which include the SERDES circuitry according to the inventive concept. Referring to FIG. 23, the system 1000 includes an application processor 1010 which controls communication, including the serial communication interfaces, with external systems and devices. Specifically, the application processor 1010 may be coupled to a speaker 1090 via an interface 1091, a microphone 1080 via an interface 1081 and a storage device 1070, such as an external memory, via an interface 1071. The application processor 1010 is also coupled to a display device 1050 via a display serial interface (DSI) 1053 and an image sensor such as a digital camera via a camera serial interface (CSI) 1043. The application processor is also coupled to an RF device such as an RF chip 1060 via a MIPI DigRF serial interface 1061.

The application processor 1010 includes a DigRF master device 1022, and the RF device 1060 includes a DigRF slave device 1028, which communicate with each other via physical layer devices 1024 and 1026, respectively, across the MIPI DigRF bus 1061, under the control of the application processor 1010.

The display device 1050 includes a DSI device 1051, and the application processor 1010 includes a DSI host device 1030. The DSI host device 1030 and the DSI device 1051 optically communicate serially with each other via the DSI bus 1053. To that end, each of the DSI host device 1030 and the DSI device 1051 includes at least a portion of the optical SERDES circuitry according to the embodiments of the inventive concept described herein. For example, the DSI device 1051 may include deserialization circuitry 1057, according to any of the embodiments of the inventive concept, for deserializing serialized optical signals received from the DSI host device 1030, which may include serialization circuitry 1055, according to any of the embodiments of the inventive concept.

The image sensor device 1040 includes a CSI device 1041, and the application processor 1010 includes a CSI host device 1020. The CSI host device 1020 and the CSI device 1041 optically communicate serially with each other via the CSI bus 1043. To that end, each of the CSI host device 1020 and the CSI device 1041 includes at least a portion of the optical SERDES circuitry according to the embodiments of the inventive concept described herein. For example, the CSI host device 1020 may include deserialization circuitry 1045, according to any of the embodiments of the inventive concept, for deserializing serialized optical signals received from the CSI device 1041, which may include serialization circuitry 1047, according to any of the embodiments of the inventive concept.

It should be noted that, unless otherwise noted or clear from the context, the term “SERDES” used herein is collectively applicable to all of the optical devices of the inventive concept, whether they perform serialization, deserialization or both serialization and deserialization.

The optical SERDES circuitry of the inventive concept may be integrated with other optical devices on the same wafer, chip or die, according to silicon photonics technology. For example, the SERDES circuitry of the inventive concept may be integrated with optical waveguides and/or optical couplers.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An optical serializer, comprising:
a source of a plurality of unmodulated optical signals;
a modulation unit for receiving the plurality of unmodulated optical signals and a respective plurality of electrical signals and generating a respective plurality of modulated optical signals using the plurality of electrical signals to modulate the plurality of unmodulated optical signals; and
a coupling unit for delaying each of the plurality of modulated optical signals by a respective delay amount to generate a respective plurality of delayed modulated optical signals and combining the plurality of delayed modulated optical signals to generate a serialized modulated optical signal.

2. The optical serializer of claim 1, wherein the coupling unit comprises:
a delay unit for delaying each of the plurality of modulated optical signals by the respective delay amount to generate the respective plurality of delayed modulated optical signals; and
an optical coupler for combining the plurality of delayed modulated optical signals to generate the serialized modulated optical signal.

3. An optical deserializer, comprising:
an optical splitter for splitting a serialized modulated optical signal into a respective plurality of modulated split optical signals;
a demodulation unit for demodulating the plurality of modulated split optical signals and generating a respective plurality of demodulated split optical signals; and
a delay unit for delaying each of the plurality of demodulated split optical signals by a respective delay amount such that the serialized modulated optical signal is converted into a respective plurality of parallel demodulated split optical signals.

4. The optical deserializer of claim 3, further comprising an optical-to-electrical conversion unit for converting the plurality of parallel demodulated split optical signals into a respective plurality of parallel electrical signals.

5. An optical deserializer, comprising:
an optical splitter for splitting a serialized modulated optical signal into a respective plurality of modulated split optical signals; and
a demodulation unit for demodulating the plurality of modulated split optical signals and generating a respective plurality of demodulated split optical signals; wherein each of a plurality of control signals is delayed by a respective delay amount to generate a respective plurality of delayed control signals, the plurality of delayed control signals being respectively applied to the plurality of demodulators such that the plurality of demodulated split optical signals are aligned in time.

6. The optical deserializer of claim 5, further comprising a delay unit for generating the plurality of delayed control signals.

7. The optical deserializer of claim 6, wherein the plurality of delayed control signals are clock signals.

8. The optical deserializer of claim 6, wherein the delay unit aligns the plurality of demodulated split optical signals in time.

9. The optical deserializer of claim 5, further comprising an optical-to-electrical conversion unit for converting the plurality of demodulated split optical signals aligned in time into a respective plurality of parallel electrical signals.

10. A data processing system, comprising:
a first transceiver circuit;
a second transceiver circuit; and
an optical communication channel between the first and second transceiver circuits; wherein:
each of the first and second transceiver circuits comprises a serializer/deserializer unit for converting between parallel electrical signals and a serialized optical signal, the serializer/deserializer unit introducing a plurality of delays into a respective plurality of split optical signals obtained by splitting an input optical signal.

11. The data processing system of claim 10, wherein the input optical signal is the serialized optical signal being deserialized into the parallel electrical signals.

12. The data processing system of claim 10, wherein the input optical signal is an unmodulated optical signal, the unmodulated optical signal being split and modulated by the plurality of parallel electrical signals to serialize the plurality of parallel electrical signals into the serialized optical signal.

13. The data processing system of claim 10, wherein each serializer/deserializer comprises a plurality of delay circuits for introducing the plurality of delays.

14. The data processing system of claim 10, wherein at least one of the first and second transceiver circuits is coupled to a semiconductor memory circuit.

15. The data processing system of claim 10, wherein at least one of the first and second transceiver circuits is coupled to a processor circuit.

16. A method of serializing a plurality of parallel electrical signals, comprising:
receiving a plurality of unmodulated optical signals;
modulating the plurality of unmodulated optical signals to a plurality of parallel modulated optical signals using a respective plurality of parallel electrical signals;
introducing a respective plurality of delays into the plurality of parallel modulated optical signals to generate a respective plurality of delayed modulated optical signals; and combining the plurality of delayed modulated optical signals into a serialized modulated optical signal.

17. A method of converting a serialized modulated optical signal to a plurality of parallel signals, comprising:
splitting the serialized modulated optical signal into a plurality of modulated split optical signals;
demodulating the modulated split optical signals into a plurality of demodulated split optical signals; and
introducing a respective plurality of delays into the plurality of demodulated split optical signals such that the plurality of demodulated split optical signals are aligned in time.

18. The method of claim 17, further comprising converting the plurality of demodulated split optical signals into a plurality of parallel electrical signals.

19. A method of converting a serialized modulated optical signal to a plurality of parallel signals, comprising:
splitting the serialized modulated optical signal into a plurality of modulated split optical signals;
demodulating the modulated split optical signals into a plurality of demodulated split optical signals; and
introducing a respective plurality of delays into a respective plurality of control signals used in demodulating the modulated split optical signals such that the plurality of demodulated split optical signals are aligned in time.

20. The method of claim 19, further comprising converting the plurality of demodulated split optical signals into a plurality of parallel electrical signals.
